(19) United States
(12) Patent Application Publication
(10) Pub. No.: US 2026/0350660 A1
(43) Pub. Date: Nov. 5, 2026

(54) SYSTEM AND METHODS FOR MODELING AD INVENTORY AND SERVING RESPONSIVE CONTENT TO A USER

(71) Applicant: Yieldmo, Inc., Nashua, NH (US)

(72) Inventors: Michael Yavonditte, Greenwich, CT (US); Edward W. Ishak, Nashua, NH (US); Alex Johnston, Seattle, WA (US); Olga Kezhapkina, Nashua, NH (US); Jarrod Dowalter, Los Angeles, CA (US); Lorena Ospina, Nashua, NH (US); Todd Coleman, Nashua, NH (US); David Sebag, New Paltz, NY (US); Daniel Michael Yavonditte, Greenwich, CT (US)

(21) Appl. No.: 19/739,406

(22) Filed: Jul. 13, 2026

Related U.S. Application Data
(63) Continuation of application No. 19/665,621, filed on May 1, 2026.
(63) Continuation of application No. 19/665,644, filed on May 1, 2026.
(60) Provisional application No. 63/890,599, filed on Sep. 30, 2025.
(60) Provisional application No. 63/847,891, filed on Jul. 21, 2025.
(60) Provisional application No. 63/810,637, filed on May 22, 2025.
(60) Provisional application No. 63/798,192, filed on May 1, 2025.
(60) Provisional application No. 63/890,599, filed on Sep. 30, 2025.
(60) Provisional application No. 63/847,891, filed on Jul. 21, 2025.
(60) Provisional application No. 63/810,637, filed on May 22, 2025.
(60) Provisional application No. 63/798,192, filed on May 1, 2025.

(51) Int. Cl. G06Q 30/0273; G06Q 30/0242

(52) U.S. Cl. CPC G06Q 30/0275; G06Q 30/0246

(57) ABSTRACT

A method includes: accessing a set of biddable objects; and accessing a corpus of web resources. The method includes, for each web resource in the corpus of web resources: extracting a set of language signals from the web resource; deriving a motif of the web resource based on the set of language signals; identifying a biddable object, in the set of biddable objects, represented within the web resource based on the motif; and associating the web resource with the biddable object. The method also includes: receiving a user prompt; extracting a set of language signals from the user prompt; identifying a set of candidate biddable objects exhibiting correspondence to the set of language signals; and, in response to detecting selection of a target biddable object, in the set of candidate biddable objects, by a user, allocating ad slots, on web resources associated with the target biddable object, to the user.

### CROSS-REFERENCE TO RELATED APPLICATIONS

This Application is a continuation of U.S. Patent Application No. 19/665,644, filed on May 01, 2026, which claims the benefit of U.S. Provisional Application Nos. 63/798,192, filed on May 01, 2025, and 63/810,637, filed on May 22, 2025, and U.S. Provisional Application Nos. 63/847,891, filed on Jul. 21, 2025, and 63/890,599, filed on Sep. 30, 2025, each of which is hereby incorporated in its entirety by this reference.

### TECHNICAL FIELD

This invention relates generally to the field of digital advertising and, more specifically, to a new and useful system and methods for modeling ad inventory and serving responsive content to a user in the field of digital advertising.

### BRIEF DESCRIPTION OF THE FIGURES

FIG. 1 is a flowchart representation of a method and a schematic representation of a system;

FIGS. 2A, 2B, and 2C are flowchart representations of a method;

FIG. 3 is a schematic representation of one variation of the method;

FIG. 4 is a flowchart representation of one variation of the method;

FIG. 5 is a flowchart representation of one variation of the method;

FIG. 6 is a flowchart representation of one variation of the method;

FIGS. 7A and 7B are flowchart representations of one variation of the method; and

FIGS. 8A and 8B are flowchart representations of one variation of the method.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. Method

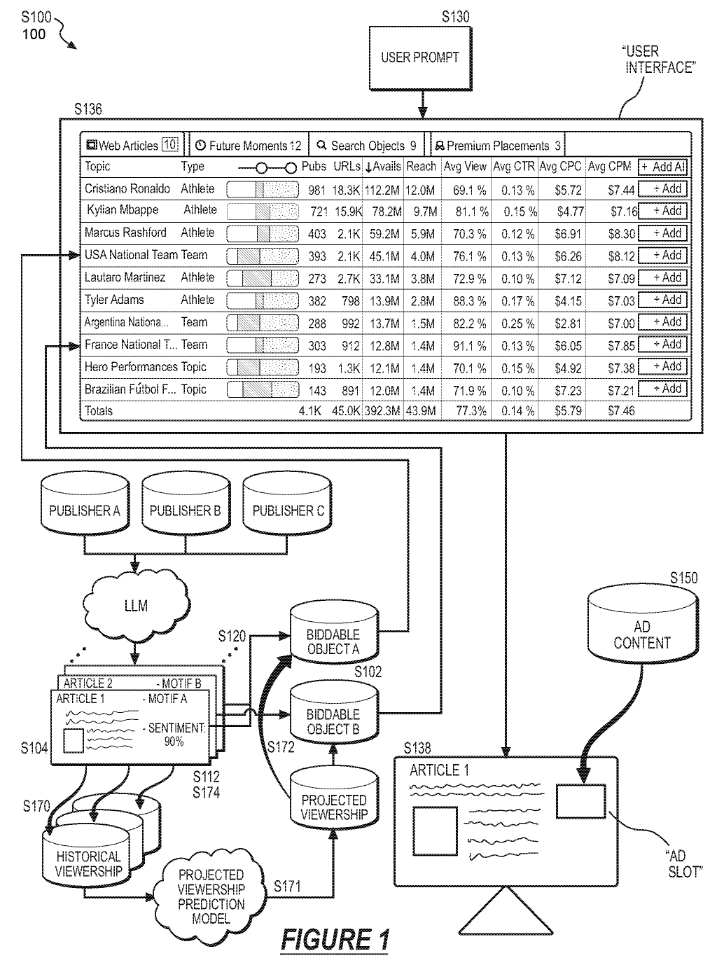

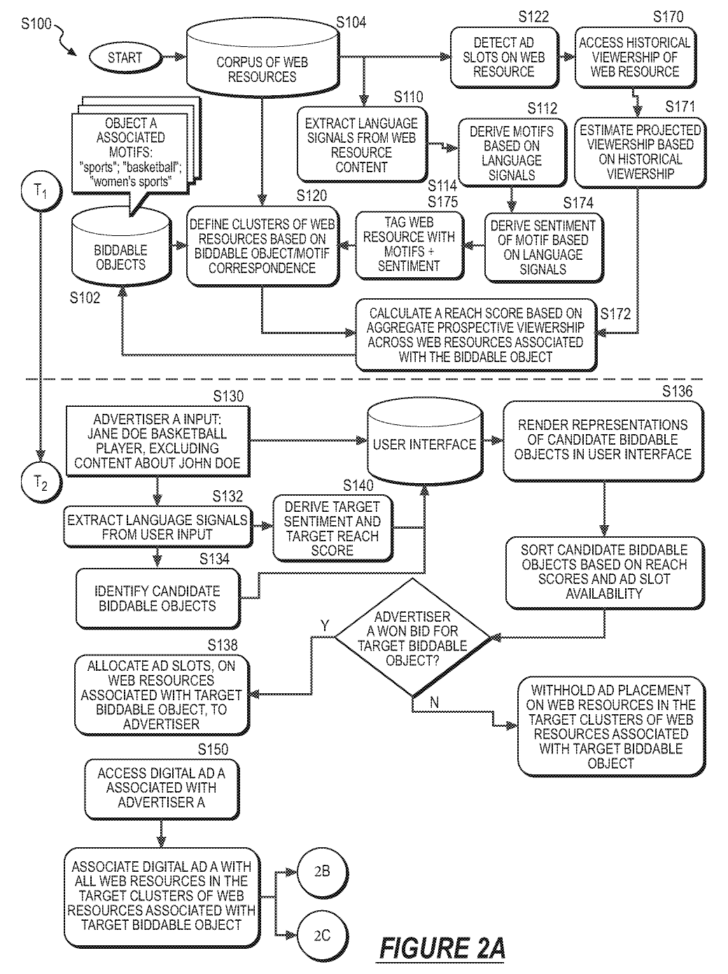

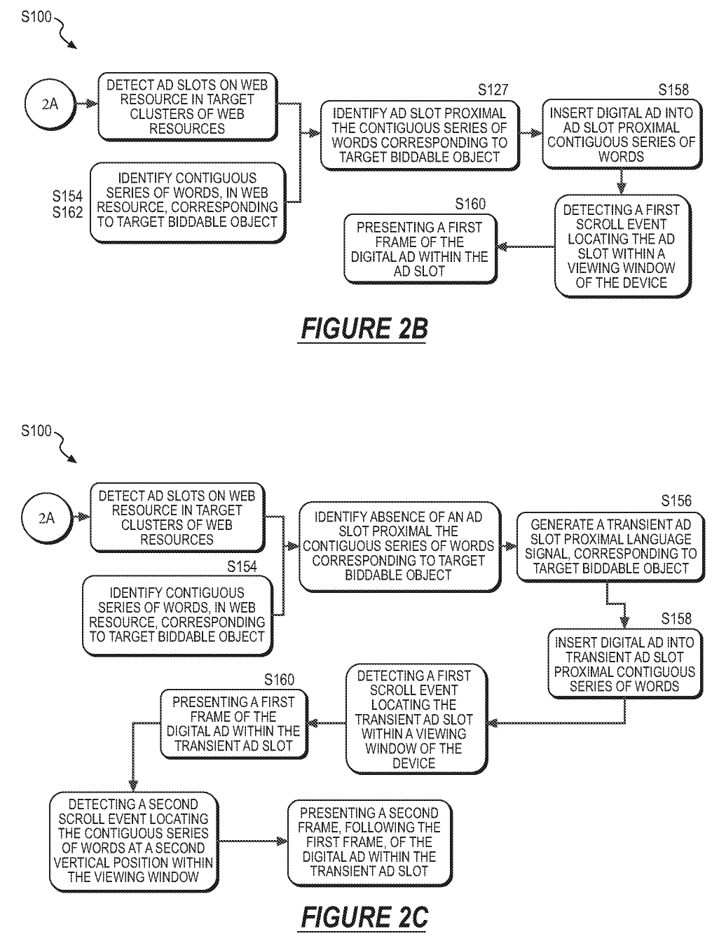

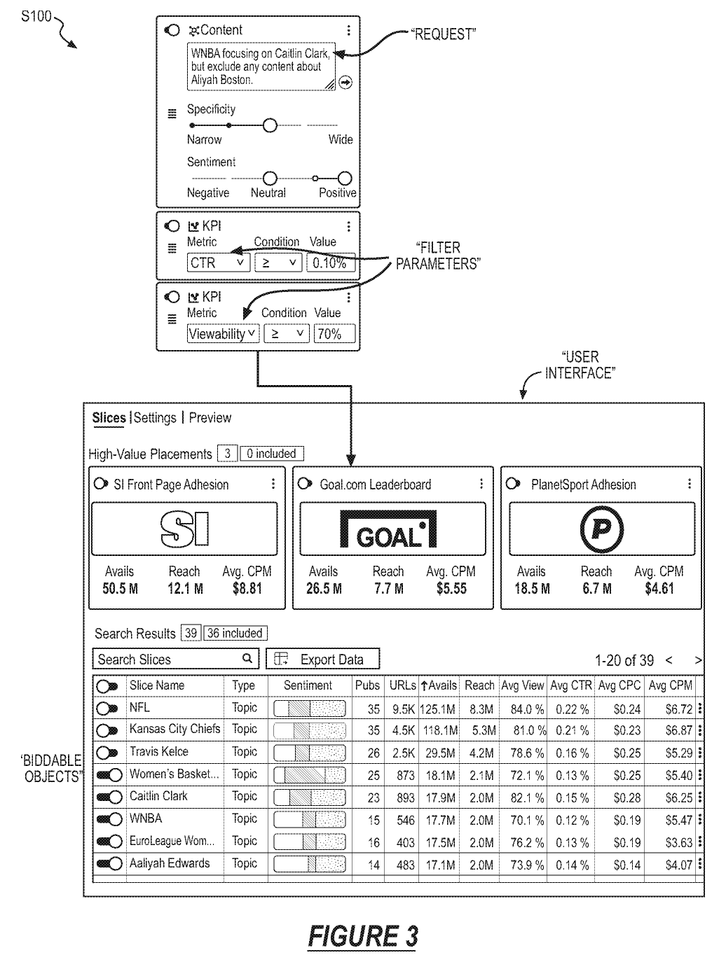

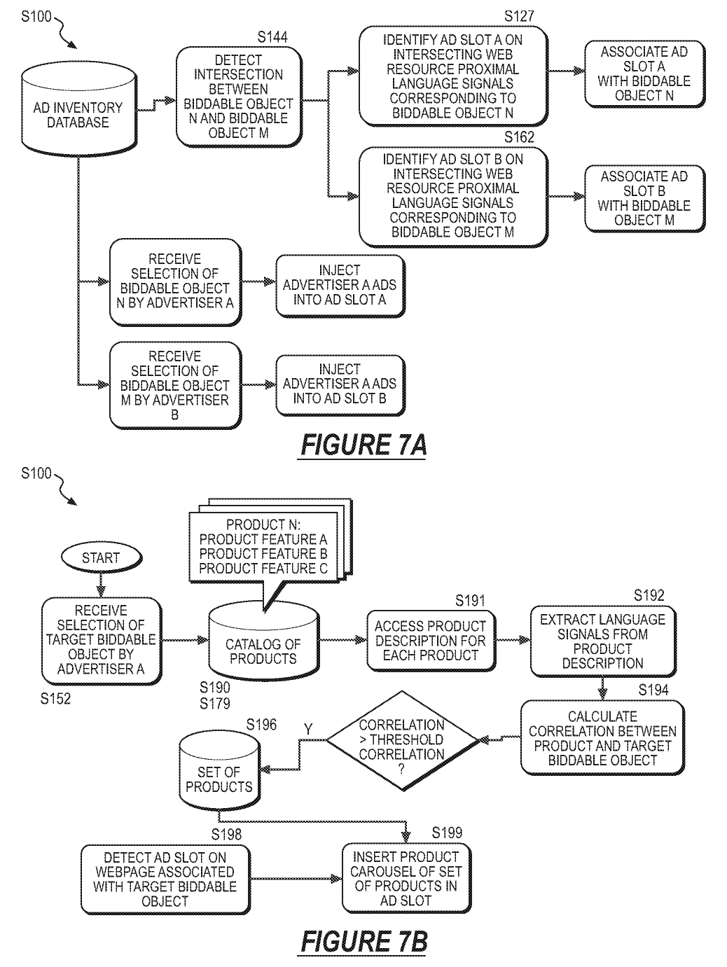

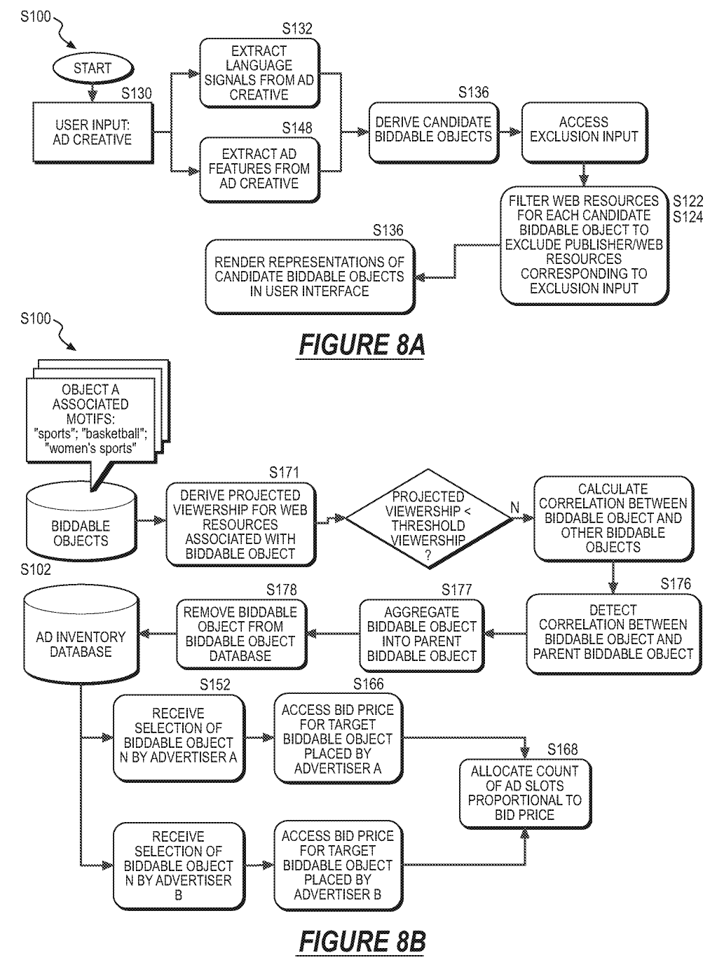

As shown in FIGS. 1-8B, a method S100 includes, during a first time period: accessing a set of biddable objects in Block S102; and accessing a corpus of web resources in Block S104.

The method S100 also includes, for each web resource in the corpus of web resources: extracting a set of language signals from content within the web resource in Block S110; deriving a motif of the web resource based on the set of language signals in Block S112; identifying a biddable object, in the set of biddable objects, represented within the web resource based on the motif in Block S114; and representing the web resource (e.g., a uniform resource locator of the web resource, a link, a pointer, a headline) in a cluster of web resources associated with the biddable object in Block S120.

The method S100 further includes, during a second time period succeeding the first time period: receiving a first user prompt, input by a user, at a user interface in Block S130; extracting a first set of language signals from the first user prompt in Block S132; identifying a set of candidate biddable objects, in the set of biddable objects, exhibiting correspondence to the first set of language signals in Block S134; presenting the set of candidate biddable objects via the user interface in Block S136; and, in response to detecting selection of a target biddable object, in the set of candidate biddable objects, by the user, at instances of web resources, in a target cluster of web resources associated with the target biddable object, allocating ad slots to ad content supplied by the user in Block S138.

### 1.1 Variation: Dynamic Biddable Objects

As shown in FIGS. 1-8B, one variation of the method S100 includes accessing a corpus of web resources in Block S104 and, for each web resource in the corpus of web resources: extracting a set of language signals from content within the web resource in Block S110; deriving a motif of the web resource based on the set of language signals in Block S112; in response to identifying a biddable object, in a set of biddable objects, associated with the motif detected in the web resource, associating the web resource with the biddable object in Block S120; accessing a set of historical viewership data for the web resource in Block S70; and estimating a projected viewership of the web resource during a future time window based on the set of historical viewership data in Block S171.

This variation of the method S100 also includes, for each biddable object in the set of biddable objects, calculating a reach score based on aggregate projected viewership of web resources associated with the biddable object in Block S172.

This variation of the method S100 further includes: receiving a first user prompt at a user interface in Block S130; extracting a first set of language signals from the first user prompt in Block S132; identifying a set of candidate biddable objects exhibiting correspondence to the first set of language signals in Block S134; presenting the set of candidate biddable objects via the user interface, each candidate biddable object in the set of candidate biddable objects ranked by reach score in Block S136; and, in response to detecting selection of a target biddable object, in the set of candidate biddable objects, by the user, allocating ad slots to ad content supplied by the user to instances of web resources associated with the target biddable object and served to viewers in Block S138.

### 1.2 Variation: Systems Integration

As shown in FIG. 1, a system 100 includes: a non-transitory computer readable medium storing instructions that, when executed by a processor, cause the processor to: access a set of biddable objects; access a corpus of web resources; for each web resource in the corpus of web resources, extract a set of language signals from content within the web resource, derive a motif of the web resource based on the set of language signals, identify a biddable object, in the set of biddable objects, represented within the web resource based on the motif, and represent the web resource in a cluster of web resources associated with the biddable object; receive a first user prompt, input by a user, at a user interface; extract a first set of language signals from the first user prompt; identify a set of candidate biddable objects, in the set of biddable objects, exhibiting correspondence to the first set of language signals; present the set of candidate biddable objects via the user interface; and, in response to detecting selection of a target biddable object, in the set of candidate biddable objects, by the user, at instances of web resources, in a target cluster of web resources associated with the target biddable object, allocate ad slots to ad content supplied by the user.

### 1.3 Variation: Prospective Biddable Objects

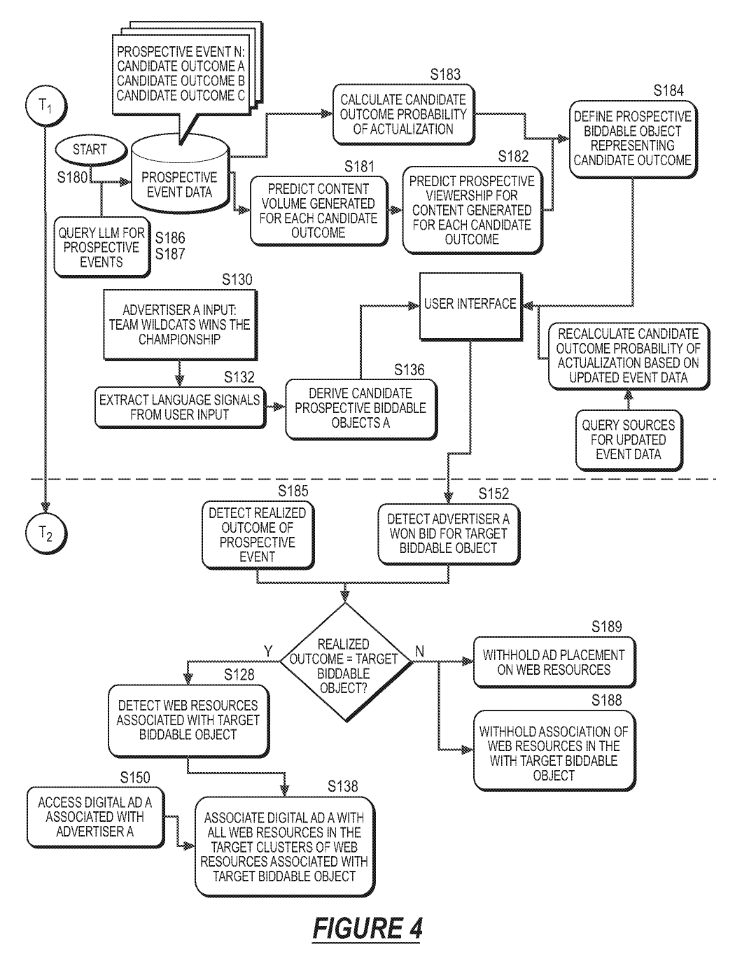

As shown in FIG. 4, one variation of the method S100 includes, during a first time period and for each future event in a set of future events projected to occur during a future time window, accessing a set of candidate outcomes associated with the future event in Block S180. This variation of the method S100 also includes, for each outcome in the set of candidate outcomes: based on historical content generation and consumption data for historical events corresponding to the future event, estimating a predicted content volume for content related to the future event during a future time window succeeding the future event in Block S181; based on historical viewership traffic associated with historical outcomes corresponding to the outcome, estimating a predicted reach score, representing prospective viewership of content related to the future event in Block S182; based on historical realized outcomes for past events corresponding to the future event, calculating an outcome probability for the outcome in Block S183; and defining a prospective biddable object, in a set of prospective biddable objects, representing the outcome, the prospective biddable object characterized by the predicted content volume, the predicted reach score, and the outcome probability in Block S184.

This variation of the method S100 further includes, during a second time period succeeding the first time period: receiving a user prompt, input by a user, at the user interface in Block S130; extracting a first set of language signals from the user prompt in Block S132; deriving a set of candidate prospective biddable objects based on the first set of language signals in Block S134; presenting the set of candidate prospective biddable objects via the user interface and responsive to the user prompt in Block S136; and, in response to detecting selection of a first prospective biddable object, in the set of candidate prospective biddable objects, by the user, allocating prospective ad slots, on prospective web resources corresponding to the first prospective biddable object, to ad content supplied by the user in Block S138.

### 1.4 Variation: Custom Biddable Objects

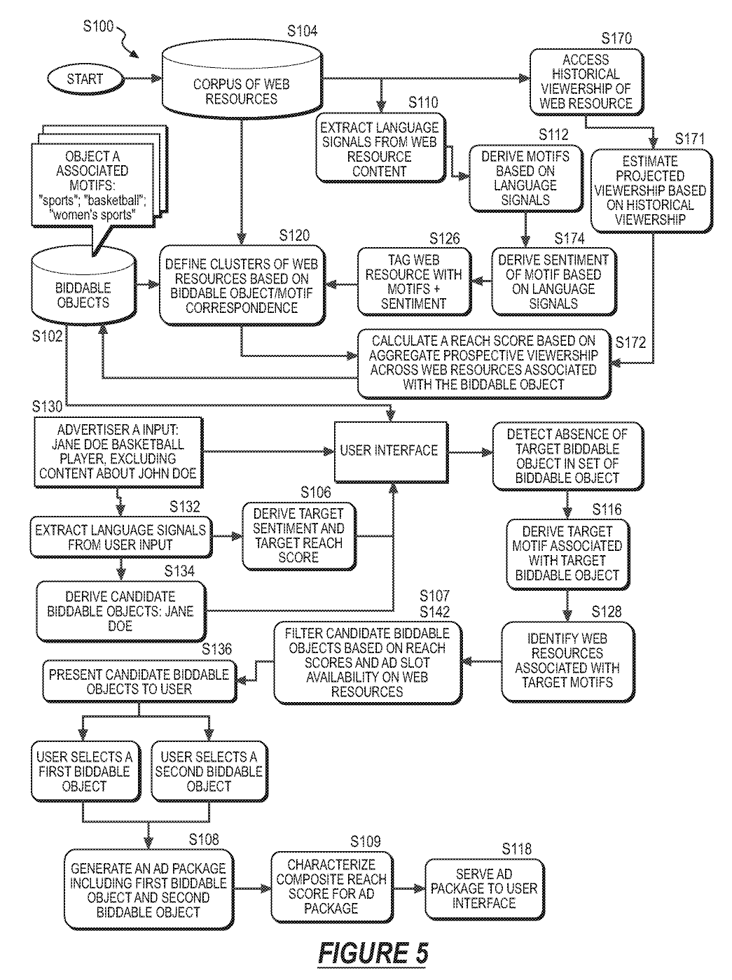

As shown in FIG. 5, one variation of the method S100 includes, during a first time period, accessing a corpus of web resources in Block S104 and, for each web resource in the corpus of web resources: extracting a set of language signals from content within the web resource in Block S110; deriving a motif of the web resource based on the set of language signals in Block S112; identifying a biddable object, in the set of biddable objects, represented within the web resource based on the motif in Block S114; and representing the web resource in a cluster of web resources associated with the biddable object in Block S120.

This variation of the method S100 also includes, during a second time period succeeding the first time period: receiving a user prompt at the user interface in Block S130; extracting a first set of language signals from the user prompt in Block S132; and identifying a set of candidate biddable objects exhibiting correspondence to the first set of language signals in Block S134.

This variation of the method S100 further includes, in response to detecting absence of the set of candidate biddable objects in the set of biddable objects and for each candidate biddable object in the set of candidate biddable objects: deriving a target motif corresponding to the candidate biddable object in Block S116; identifying a set of web resources, in the corpus of web resources, representing content associated the target motif in Block S128; and representing the set of web resources in a cluster of web resources associated with the candidate biddable object in Block S120.

This variation of the method S100 also includes: presenting the set of candidate biddable objects via the user interface in Block S136; and, in response to detecting selection of a target biddable object, in the set of candidate biddable objects, by the user, at instances of web resources, in a target cluster of web resources associated with the target biddable object, allocating ad slots to ad content supplied by the user in Block S138.

### 1.5 Variation: Search Objects

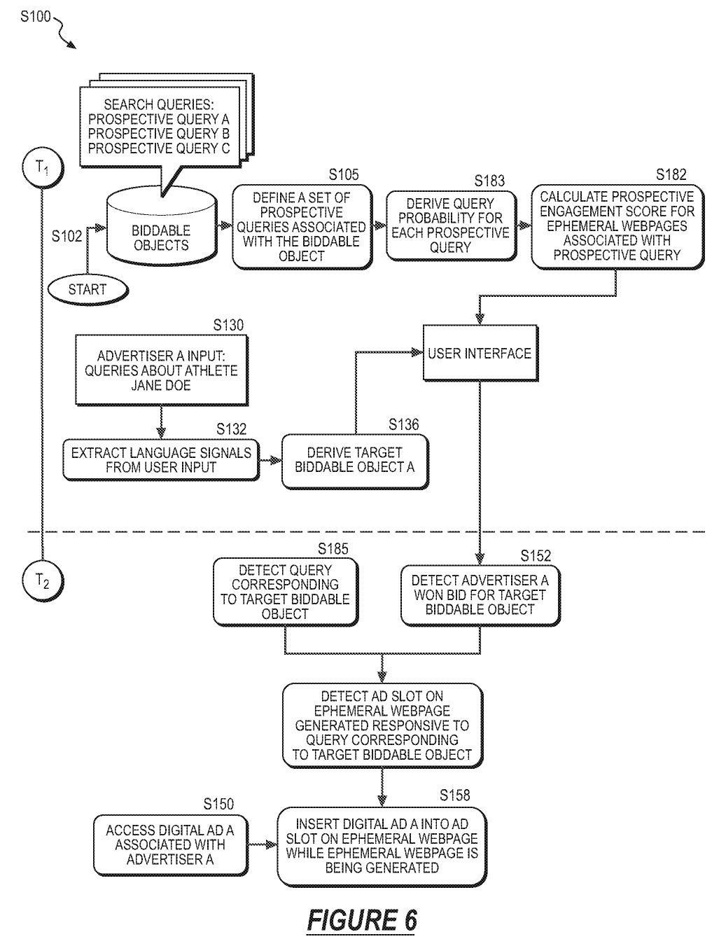

As shown in FIG. 6, one variation of the method S100 includes, during a first time period, deriving a set of biddable objects representing prospective search queries in Block S102.

This variation of the method S100 also includes, for each biddable object in the set of biddable objects: defining a set of search queries corresponding to the biddable object in Block S105; calculating a predicted viewership for ephemeral webpages associated with the set of search queries in Block S181; calculating a query probability representing a likelihood of a user inputting a search query in the set of search queries in Block S183; and characterizing the biddable object based on the predicted engagement score and the query probability in Block S184.

This variation of the method S100 further includes, during a second time period succeeding the first time period: receiving a user prompt at the user interface in Block S130; extracting a first set of language signals from the user prompt in Block S132; identifying a set of candidate biddable objects, in the set of biddable objects, exhibiting correspondence to the first set of language signals in Block S134; presenting the set of candidate biddable objects via the user interface and responsive to the user prompt in Block S136; and, in response to detecting selection of a target biddable object, in the set of candidate biddable objects, by the user, allocating ad slots to ad content supplied by the user at instances of ephemeral webpages corresponding to the target biddable object in Block S138.

### 2. Applications

Generally, the method S100 can be executed by a computer system (e.g., a remote computer system, a computer network, a remote server) in conjunction with a publisher platform: to access a corpus of web resources published across a population of publishers; to implement a language model to detect motifs (e.g., language concepts representing public figures, themes, events, or entities) in these web resources; to group these web resources into clusters of web resources exhibiting common motifs detected in these web resources; to access and/or define a list of biddable objects; to associate a cluster of web resources with a biddable object, based on correspondence between a motif represented by the cluster of web resources and a concept represented by the biddable object. For example, the computer system can: consolidate a large corpus of distinct web content (e.g., news articles, blog posts, video content) into clusters that exhibit common themes (i.e., motifs); and to pair these clusters with biddable objects that represent a singular concept that may be purchased by an advertiser to distribute advertising content across all of this web content in the cluster.

Then, the computer system can: receive a prompt (e.g., an ad creative, an ad campaign objective, a text prompt, a media file, a URL) uploaded by an advertiser; automatically filter available biddable objects based on concepts specified by the prompt such that the computer system retrieves a subset of biddable objects that correspond to the prompt; present the subset of biddable objects to the advertiser; and, in response to selection of a target biddable object by the advertiser, to allocate advertising rights across the entire cluster of web resources associated with the target biddable object to the ad campaign.

Accordingly, by aggregating web resources — spanning a long tail of publishers, websites, and webpages characterized by heterogeneous individual viewership levels — into a single biddable object, the computer system can enable advertisers to purchase a unified ad package that is contextually aligned with a target motif and brand, and deployed across the full scope of that cluster of web resources through a single confirmation, without requiring the advertiser to individually review, select, or contract with each publisher or web resource in the cluster of web resources. Furthermore, by deriving predicted viewability scores for each web resource in the cluster from historical engagement data and aggregating those scores into a composite reach score for a particular biddable object, the computer system can present advertisers with a more statistically robust and actionable forecast of aggregate campaign performance than single-placement viewability estimates.

More specifically, the computer system can implement Blocks of the method S100 to: organize web resources — across multiple publishers, websites, and webpages — — into clusters based on common themes (or “motifs”) represented in text, images, or other media in these web resources; define a discrete, normalized biddable object for each cluster, representing the motif of the cluster of web resources as a single, uniquely identifiable, and purchasable inventory concept; match an entire cluster of web resources to a specific advertiser or ad campaign based on alignment between the biddable object represented by the cluster of web resources and the characteristics of a campaign objective; and allocate advertising rights across the entire cluster of web resources to the ad campaign responsive to confirmation of (e.g., purchase of) the biddable object by the advertiser, thereby enabling the advertiser to deploy an ad campaign across many publishers, webpages, and websites through a single selection.

In particular, the computer system can associate a representation of a web resource (e.g., a uniform resource locator, a pointer, a link) with the biddable object such that, in response to user selection of the biddable object, the computer system can render a list of representations of web resources associated with the biddable object to thereby enable the user to further refine (e.g., select, deselect, filter) web resources represented in the cluster of web resources associated with the biddable object, such as prior to purchasing the biddable object.

Furthermore, the computer system can implement Blocks of the method S100 to present biddable object inventory to an advertiser via a natural-language search interface (or "prompt-based search") (e.g., a text prompt, an uploaded media file, a URL) that enables the advertiser to identify contextually aligned inventory without browsing publisher catalogs or constructing keyword lists. In response to receiving a prompt from the advertiser, the computer system can: extract a set of language signals from the prompt; derive a target biddable object (and/or a set of candidate biddable objects) from the language signals; and present a representation of the target biddable object, annotated with composite predicted viewership metrics, sentiment composition, and publisher distribution across a cluster of web resources associated with the target biddable object, to the advertiser via a user interface.

In particular, the computer system can: leverage past (e.g., historical) user engagement data for these web resources to calculate projected viewership predicting future user viewership and/or engagement with these web resources and calculate reach scores – based on composite projected viewership for these web resources associated with the biddable object – for biddable objects; and annotate representations of these biddable objects with reach scores to enable a user to filter candidate biddable objects by target reach scores, viewability, and/or predicted engagement with these web resources.

In one implementation, the computer system can: predict aggregate future user engagement across each cluster of web resources based on predicted future user engagements with each web resource in the cluster of web resources; access characteristics (e.g., motifs of interest, keywords, brand concepts, inclusion and exclusion concepts) of an advertiser; match the advertiser – or a current or upcoming ad campaign – to a cluster of web resources based on correspondence between the motif of the cluster of web resources and the characteristics of the advertiser; and to allocate advertising rights across the entire cluster of web resources (i.e., rather than a single web resource, a single ad slot per web resources, or a single publisher) to the advertiser’s current or future ad campaign based on this correspondence.

More specifically, the computer system can implement Blocks of the method S100 to: group web resources – across multiple or many publishers, websites, and webpages, etc. – into clusters based on common themes (or “motifs”) represented in text, images or other media in these web resources; match an entire cluster of web resources to a specific advertiser or ad campaign based on alignment (e.g., correspondence) between a motif of the particular cluster of web resources and characteristics of the specific advertiser or ad campaign; and to assign or allocate advertising rights across the entire cluster of web resources to the specific advertiser or ad campaign, thereby enabling the advertiser to deploy an entire ad campaign across many publishers, webpages, websites, etc. through a single portal and agreement.

Furthermore, the computer system can implement Blocks of the method S100 to predict future engagement with the ad campaign deployed across the cluster of web resources based on past (i.e., historical) engagement data for these web resources. The computer system can then: set an advertising time window for the ad campaign based on this future engagement and a target engagement for the ad campaign; estimate a value of the ad campaign deployed within an advertising time window based on this future engagement; and/or tighten or loosen a scope of the biddable object associated with the cluster of web resources to better match the cluster of web resources and the ad campaign to an advertising time window, a value of the ad campaign deployed on this cluster of web resources, and/or a target engagement for the ad campaign.

In particular, the computer system can define an ad campaign for an advertiser based on the available inventory and a set of target parameters defined by the advertiser – such as an outcome type (e.g., viewability, video completion rate, and/or click-through rate), a particular advertisement format, and/or a particular content type (e.g., webpage content type, ad content type) – based on predicted outcomes for advertising content presented within these ad slots. The computer system can therefore: identify groups of ad slots – including ad slots dispersed across many web resources affiliated with many publishers – predicted to yield high engagement with advertising content presented within ad slots, in these groups of ad slots, and characterized by a particular biddable object.

Furthermore, the computer system can present these motifs as biddable objects to an advertiser. In response to confirmation of a particular biddable object associated with a first motif by an advertiser, the computer system can associate the particular biddable object, associated with a subset of web resources within the corpus of web resources and an associated subset of ad slots present within the subset of web resources, with the advertiser, characterized by a set of ad concepts associated with the first biddable object. Thus, in response to identifying an instance of a web resource, in the subset of web resources, loaded on an endpoint device, the computer system can: access advertisements associated with a set of ad concepts the advertiser; and populate ad slots within the instance of the web resource associated with (e.g., characterized by, representing) the first biddable object.

Accordingly, the computer system can present biddable, concept-level ad inventory — defined by a discrete biddable object representing a motif shared across a population of web resources — and enable advertisers to purchase and deploy ad campaigns across the full scope of that inventory through a single interface. Therefore, the computer system can implement Blocks of the method S100 to: increase available ad inventory across a corpus of web resources spanning a population of publishers — thereby increasing revenue opportunity for publishers and availability of high-engagement inventory for advertisers; improve the contextual relevance of ad placements by inserting ads proximal the content signals (or "keyword anchors") within a web resource; and reduce the effort required for an advertiser to construct, launch, and maintain a contextually targeted ad campaign across a large and dynamic corpus of publisher inventory.

### 2.1 Ad Placement: Contextual Ad Slots

In one implementation, the computer system can inject digital ads into ad slots in a web resource at locations contextually proximal to specific content signals (e.g., a contiguous series of words in the body of the web resource associated with a target biddable object), such as rather than at fixed, pre-defined ad slot positions in the web resource. In particular, the computer system can: access a web resource in the cluster associated with a selected biddable object; scan the body of the web resource for a contiguous series of words representing content signals corresponding to the biddable object; generate a transient ad slot (e.g., a dynamically generated ad placement) proximal the contiguous series of words; and insert a digital ad, associated with the advertiser, into the transient ad slot.

Accordingly, the computer system can place ads at precise locations, within a web resource, proximal content referencing the target biddable object. Therefore, the computer system can: increase contextual relevance of ad placements by positioning ads adjacent editorial content directly referencing the purchased biddable object; and improve viewability by placing ads at webpage locations actively viewed by a viewer.

### 2.2 Biddable Objects: Prospective Objects

In one implementation, during a first time period, the computer system can: generate a set of prospective biddable objects representing candidate outcomes of a future event projected to occur during a target time window; derive an outcome probability for each candidate outcome based on prospective event data; estimate a predicted web resource inventory, representing predicted content volume generated for the candidate outcome, for each candidate outcome; calculate a predicted viewability score for each prospective biddable object representing predicted user engagement with content generated for the candidate outcome; and present the set of prospective biddable objects — characterized by a predicted inventory size, predicted viewability score, and outcome probability — to advertisers via a user interface for selection prior to the future event. In particular, in response to receiving confirmation of a first prospective biddable object by a first advertiser, the computer system can: allocate advertising rights of prospective ad slots associated with that outcome to the first advertiser; and, during a third time period following occurrence of the future event, identify a realized outcome of the future event and in response to the realized outcome corresponding to the first prospective biddable object, access a corpus of web resources published in connection with the realized outcome, associate those web resources with the first prospective biddable object, and insert digital ads associated with the first advertiser into ad slots on those web resources. Additionally or alternatively, the computer system can withhold campaign activation and ad insertion for an advertiser who purchased a prospective biddable object corresponding to a candidate outcome that was not realized.

In one implementation, during a first time period, the computer system can: generate a corpus of prospective biddable objects that may be represented in future web resources published by a population of publishers; and receive confirmation of a particular prospective biddable object, in the corpus of prospective biddable objects, by an advertiser. During a second time period, he computer system can also: access a corpus of new web resources published by the population of publishers; interpret motifs within this corpus of new web resources; associate these web resources with prospective biddable objects based on motifs represented across these web resources; and, in response to detecting a particular motif corresponding to (e.g., representing) the particular prospective biddable object, in a particular new web resource in the corpus of new web resources, inject an ad associated with the advertiser into an ad slot on the particular web resource.

In particular, in this implementation, the computer system can: generate a corpus of prospective biddable objects representing hypothetical future themes, events, actions, such as based on current trends, predicted future trends, current events, and/or advertiser preferences; characterize a “reach score” for each biddable object in the corpus of prospective biddable objects, each reach score representing aggregate projected viewership across web resources, and accordingly engagement with ad slots represented within these web resources, that include the prospective biddable object; receive confirmation by a particular advertiser of a first prospective biddable object, in the corpus of prospective biddable objects, for implementation of an ad campaign related to the first prospective biddable object and the advertiser; and, during a target time period, in response to identifying a first web resource representing the first prospective biddable object, inject an ad, from the ad campaign, into an ad slot on the first web resource.

In one example, the computer system can characterize an impact score representing a potential value for each prospective biddable object, in the corpus of prospective biddable objects, based on a probability of a candidate outcome corresponding to the prospective biddable object occurring. In particular, the computer system can leverage historical data and real-time event indicators to calculate a probability of occurrence for each candidate outcome in a corpus of candidate outcomes.

The computer system can then populate an ad projection database with the corpus of prospective biddable objects, each prospective biddable object characterized by an impact score. In response to receiving an advertiser confirmation for a first prospective biddable object, such as based on a first impact score associated with the first prospective biddable object, the computer system can associate the advertiser and the first prospective biddable object such that, when web resources are published that reference the first prospective biddable object (e.g., based on real-time language concepts detected within these web resources), the computer system can push advertisements, associated with this advertiser, to ad slots present on these web resources.

Accordingly, the computer system can represent prospective concepts as prospective biddable objects, as described herein, and present these prospective biddable objects to advertisers such that an advertiser may purchase a prospective biddable object prior to actuation of a candidate event – or event outcome – represented by the prospective biddable object, enabling real-time ad placement for relevant concepts. Therefore, in this implementation, the computer system can increase available ad inventory across a corpus of web resources, thereby increasing opportunity for revenue generation for a publisher and/or increasing availability of high-engagement ad inventory for advertisers. Further, by generating increased ad campaign opportunities in (near) real-time, the computer system can promote increased salience of advertiser campaigns, thereby enabling increased opportunity for brand lift (e.g., brand awareness) and/or conversions (e.g., product purchases) associated with these ads.

### 2.3 Biddable Objects: Dynamic Objects

In one implementation, the computer system can generate biddable objects on demand, such as in response to receiving a prompt from an advertiser for a target concept excluded from a pre-defined set of biddable objects. In particular, the computer system can: receive a prompt from the advertiser defining a custom concept, theme, or targeting constraint; extract a set of language signals from the prompt; detect absence of a corresponding biddable object, in the set of biddable objects, to the set of language signals; derive a target motif associated with the user-defined concept; scan the corpus of web resources to identify web resources representing the target motif; aggregate these web resources into a dynamic cluster of web resources; and define a dynamic biddable object associated with the dynamic cluster of web resources.

Furthermore, the computer system can implement Blocks of the method S100 to present the dynamic biddable object to the advertiser via a user interface, annotated with composite predicted viewership metrics, sentiment composition, and publisher distribution of web resources associated with the dynamic biddable object, enabling the advertiser to evaluate and confirm the dynamic biddable object prior to campaign activation. In response to receiving confirmation of the dynamic biddable object by the advertiser, the computer system can implement methods and techniques as described herein to: associate the dynamic biddable object with the advertiser's ad campaign; allocate advertising rights across the dynamic cluster of web resources to the ad campaign; and, during a target time window, in response to identifying an instance of a web resource in the dynamic cluster loaded on an endpoint device, access advertisements associated with the advertiser and populate ad slots within that web resource with those advertisements.

In one implementation, the computer system can continuously monitor the corpus of web resources to identify newly published web resources representing the target motif associated with a dynamic biddable object. In response to identifying a new web resource representing the target motif, the computer system can: associate the new web resource with the dynamic cluster; update the reach score for the dynamic biddable object to reflect the expanded cluster; and insert digital ads associated with the advertiser into ad slots on the new web resource.

In one example, in response to receiving a prompt from an advertiser specifying a highly specific concept (e.g., a product category, a geographic event, a brand-adjacent theme), the computer system can: determine that no pre-defined biddable object sufficiently represents the concept; and dynamically generate a biddable object tailored to the advertiser's specification. The computer system can further refine the scope of the dynamic biddable object by: accessing inclusion or exclusion constraints from the advertiser (e.g., keywords, topics, or publisher categories to include or exclude from the dynamic cluster); applying these constraints to filter web resources in the cluster of web resources; and recalculating a reach score and predicted viewability for the dynamic cluster of web resources, thereby enabling the advertiser to iteratively tune the dynamic biddable object to meet target campaign objectives.

Accordingly, the computer system can expand available advertising inventory beyond the set of pre-defined biddable objects in response to advertiser demand — without manual platform operator intervention. Therefore, the computer system can: enable advertisers with custom campaign objectives to construct inventory aligned with unique targeting requirements; support real-time inventory generation for newly emerging concepts and events not yet indexed into pre-defined clusters; and increase the total addressable inventory available through the platform.

### 2.4 Search Objects

In one implementation, the computer system can generate biddable objects representing prospective search queries on publisher webpages (hereinafter “search objects”) — such as biddable objects associated with ephemeral pages dynamically generated in response to user search activity, rather than existing and/or persistent web resources. In particular, the computer system can: characterize each search object based on projected search query frequency and predicted viewership and/or user engagement with ephemeral webpages; serve the search objects to a user interface for selection by advertisers; and insert digital ads associated with advertisers into ad slots on ephemeral pages generated in response to corresponding search queries at publisher webpages.

More specifically, the computer system can define, for each search object, a set of search queries representing a range of query strings that a user may input at a publisher search interface to trigger generation of an ephemeral page associated with a particular search object. The computer system can: monitor publisher search interfaces for incoming search queries; in response to detecting a search query corresponding to a search object purchased by an advertiser, identify an ad slot on the ephemeral page dynamically generated in response to the query; and insert a digital ad associated with the advertiser into the ad slot in real time as the ephemeral page is generated to thereby enable ad insertion into pages generated in real time.

Accordingly, the computer system can represent prospective search queries as biddable objects available for advance purchase in an ad inventory database – rendered via a user interface – to thereby expand a biddable object inventory to inventory that does not exist at bid time and is generated in real time (e.g., each time a user submits a corresponding search query at a publisher webpage). Therefore, the computer system can implement Blocks of the method S100 to: enable advertisers to purchase concept-level inventory on publisher search pages before these ephemeral webpages are generated and before the user interactions that trigger generation of such ephemeral webpages; match and insert advertiser digital ads into dynamically-generated search result pages at query time; and expand available pre-purchase inventory to include search-query-initiated ephemeral inventory without a persistent URL and that would otherwise be unavailable for advance purchase.

### 3. Inventory Aggregation

Generally, the computer system can aggregate a set of web resources into an ad inventory database based on tags representing motifs identified in these web resources, ad availability within these web resources, and/or predicted ad viewership. In particular, the computer system can: scan a particular web resource for a set of content signals; derive a motif of the web resource based on the set of content signals; derive a sentiment for the motif based on the set of content signals; generate a set of tags for the web resource based on motifs present within the web resource; and generate a set of clusters of web resources, each cluster including web resources exhibiting a particular tag and/or subset of tags. In one implementation, the computer system can define a cluster of web resources associated with a particular object (e.g., a biddable object) associated with a target motif, as further described herein.

In one implementation, the computer system can access a set of web resources generated by (e.g., published by) a publisher, in a corpus of publishers, during a target time interval. The computer system can receive a set of web resources transmitted (or “pushed”) from each publisher in the set of publishers. In this implementation, the computer system can: periodically receive a set of web resources, published during the target time interval, pushed from the publisher at a predefined frequency (e.g., once per hour, once per day); and implement methods and techniques described below to characterize (or “tag”) these web resources.

In another implementation, the computer system retrieves the set of web resources from the publisher. For example, the computer system can request (or “poll”) a publisher for a first set of web resources via a first application programming interface (or "API") (or “API”) call. In this example, the computer system can receive the first set of web resources from the publisher in response to the first API call. In this implementation, the computer system can periodically poll the publisher for a set of web resources at a predefined frequency (e.g., once per hour, once per day).

In another implementation, the computer system can interface with a publisher platform (e.g., a native application) accessed by a publisher (e.g., an administrator affiliated with the publisher) to generate an inventory database representing a corpus of ad slots defined across a set of web resources affiliated with the publisher.

In one implementation, the computer system can: prompt the publisher to provide a set of URLs — corresponding to a set of web resources (e.g., webpages) — affiliated with the publisher; scrape each web resource, in the set of web resources, to identify a set of ad slots located on the web resource; and, for each ad slot, in the corpus of ad slots identified across the set of web resources, access a set of ad slot data, such as including a position of the ad slot within a web resource, a size of the ad slot, a URL of the web resource containing the ad slot, etc. The computer system can then: generate an ad slot container, in a set of ad slot containers, for each ad slot in the host of ad slots; store each set of ad slot data in a corresponding ad slot container in the set of ad slot containers; and compile the set of ad slot containers into a robust inventory database for the publisher.

Additionally, in one variation, the computer system can continuously update the ad inventory database according to newly published web resources. In particular, during a first time period, the computer system can: implement methods and techniques as described herein to characterize a first corpus of web resources published during a first target time period; and implement methods and techniques as described herein to characterize a second corpus of web resources published during a second target time period (immediately) succeeding the first target time period.

In one example, the computer system can access a second corpus of web resources published subsequent to the first time period and, for each web resource in the second corpus of web resources: extract a set of language signals from content within the web resource; derive a motif of the web resource based on the set of language signals; identify a biddable object, in the set of biddable objects, represented within the web resource based on the motif; and represent the web resource in a cluster of web resources associated with the biddable object. In one implementation, the computer system can: calculate a projected viewership for the web resource for a future time window (e.g., a projected duration of an ad campaign); calculate an engagement score (or "performance prediction") for ads served to ad slots in the set of ad slots based on historical traffic across the web resource; and annotate the web resource with the projected viewership and the engagement score (i.e., a predicted metric representing future ad performance) in Block S126.

Accordingly, the computer system can generate — and continuously update — an ad inventory database based on a corpus of web resources (e.g., millions of web resources) across a corpus of publishers (e.g., 1000s of publishers).

### 3.1 Web Resource Indexing

Generally, the computer system can: access a web resource published on a webpage; parse the web resource for target concepts; and identify a set of content signals in the web resource for pushing ads embedded within (e.g., overlayed over, attached to keywords in) the web resource. In particular, the computer system can: receive a notification of a web resource (e.g., a web resource published within a target time window); access the web resource via the webpage; scan content within the web resource for language concepts representing target concepts and/or target content signals; characterize the web resource, such as by implementing natural language processing (NLP) and/or large language model (LLM) methods; and, based on identified language concepts and characterization, associate the web resource with a set of tags representing concepts found within the web resource.

In one example, the computer system can: access a particular web resource (e.g., a news web resource, an opinion piece, a sports web resource); scan a body of the web resource for language concepts (or "semantic tags") representing key concepts, such as a motif (i.e., a dominant theme or concept) and/or topic of the web resource; characterize the web resource based on a first set of language concepts identified in the body of the web resource, the motif of the web resource and/or the topic of the web resource; and identify a sentiment (e.g., positive, negative, neutral) associated with the web resource based on a second set of language concepts proximal the first set of language concepts. The computer system can then: generate a set of tags representing these language concepts; and associate the set of tags with the web resource. Accordingly, the computer system can characterize web resources based on language concepts and/or content signals identified within these web resources.

In particular, the computer system can implement methods and techniques as described herein to derive tags, motifs, and content signals for each web resource in a corpus of web resources across a population of publishers (e.g., 100s, 1000s of publishers) — thereby aggregating a supply of tagged web resources into the ad inventory database for supply-side search and ad placement, as described herein.

Therefore, the computer system can associate each web resource in the corpus of web resources with a set of tags representing motifs and content signals identified within the web resource, such that an ad inventory database includes a tagged corpus of web resources organized by motif.

### 3.2 Web Resource Sentiment

Generally, the computer system can derive a sentiment for a web resource based on language signals and content signals identified within the web resource in Block S174. In particular, the computer system can: identify a set of content signals representing a motif within the web resource; identify a set of language concepts proximal the content signals; and derive a sentiment (e.g., positive, negative, neutral) associated with the motif based on the set of language concepts. The computer system can then annotate the web resource with the sentiment in Block S175.

In one implementation, the computer system can identify a sentiment associated with particular content signals identified within the web resource. In particular, the computer system can: identify a set of language concepts (e.g., emotional sentiment, tone indicators, objective viewpoints) proximal a content signal corresponding to a motif (e.g., a motif representing and/or associated with a biddable object); identify a syntactic context (e.g., win, loss) of the content signal; and characterize a sentiment for the motif based on a sentiment classification model and the set of language concepts.

For example, for each web resource in the corpus of web resources, the computer system can: derive a sentiment for the web resource based on the set of language signals extracted from content within the web resource; and annotate the web resource with the sentiment. Accordingly, the computer system can annotate a representation of the web resource – such as a representation of the web resource within an ad inventory database or a user interface – with a sentiment and/or a sentiment score for each motif represented in the web resource.

In one example, the computer system can implement methods and techniques described herein to characterize a sentiment for each content signal in a set of content signals within a web resource. The computer system can then leverage each sentiment to characterize a web resource sentiment associated with the motif of the web resource.

In one example, the computer system can: identify a particular content signal representing a public figure associated with an advertiser; access a target sentiment associated with the public figure, such as from the advertiser profile; identify a sentiment (e.g., positive, negative) associated with the public figure; and, in response to identifying a correlation between the sentiment and the target sentiment, the computer system can associate the web resource with the advertiser.

### 3.3 Analytics + Projected Viewership + Predicted Engagement

Generally, the computer system can calculate a set of predicted engagement scores (e.g., projected viewership, viewability, engagement), representing future viewership and user engagement with ad slots of the web resource for each web resource, based on past engagement metrics representing visitor traffic and user engagement with the particular web resource.

In one implementation, the computer system can access a set of viewership metrics for a particular web resource — such as including: a viewership count of the web resource — representing a count of users accessing instances of the web resource via the publisher; and an engagement count representing viewer engagements with ad slots on the web resources.

In the foregoing implementation, the computer system can additionally characterize a temporal salience score (or "recency weight") for the web resource — representing a timeliness relevance for the web resource. In particular, the computer system can characterize the temporal salience score (or "recency weight") for a motif represented in the web resource based on: a count of web resources, in the corpus of web resources, including the motif; a set of engagement scores associated with these web resources, the set of engagement scores representing interactions (e.g., clicks, scrolls, etc.) with these web resources, as described herein; and/or sentiments associated with the motif (e.g., generally positive, generally negative). The computer system can then: associate the temporal salience score (or "recency weight") with the web resource and/or the motif for filtering of web resources and/or motifs within the ad inventory database.

Additionally or alternatively for each web resource in the corpus of web resources, the computer system can calculate a projected viewership for the web resource during a target time period (e.g., a future time period, a projected time period of an ad campaign) based on historical viewership of the web resource. In particular, the computer system can: access historical viewership data for the web resource; characterize a temporal salience score for a motif represented in the web resource, as described above; and calculate the projected viewership based on the historical viewership data and the temporal salience score.

In one implementation, the computer system can compile engagement data collected for ad slots across the set of web resources, affiliated with the publisher, into an engagement profile generated for the web resource. The engagement profile can thus contain information representing historical interactions of users with advertising content presented within ad slots across the web resource. For example, for each instance of each ad slot on a particular web resource, the computer system can access a set of engagement data, such as: a position of the ad slot within a window rendered on a display of a computing device; a number of pixels of the ad slot in view in the window; clicks over the ad slot; vertical scroll events that move the ad slot within the window; horizontal swipes over the ad slot; hotspot selections within the ad slot; video plays, pauses, and resumes within the ad slot; metadata of the webpage containing the ad slot; etc. The computer system can then: insert each set of engagement data collected for this ad slot into an ad slot container, in a set of ad slot containers, generated for this ad slot; and compile the set of ad slot containers — representing historical user engagement with each slot in the host of ad slots — into an engagement profile for the web resource. Additionally, the computer system can similarly link each set of engagement data for a particular ad slot to (dynamic) ad slot data — such as a time of day, device data (e.g., a geographic location, a device type), ad metadata, web resource metadata at the particular time of day — collected for each instance of the ad slot accessed by a particular user computing device in a population of user computing devices.

In one implementation, the computer system can leverage historical engagement data contained in a publisher engagement profile to characterize performance of a particular ad slot, in a host of ad slots across web resources published by the publisher, according to a set of target parameters, such as a particular target outcome (e.g., VCR, CTR, viewability), a particular advertisement format, a particular content type (e.g., webpage content, advertising content), etc. In particular, in this implementation, the computer system can: access an ad slot container associated with the particular ad slot and containing a corpus of engagement data representing user interactions with advertising content presented within the particular ad slot during a target time period; and, based on the corpus of engagement data, derive a set of predicted engagement scores representing performance of advertising content presented within the ad slot according to the set of target parameters (e.g., a particular target outcome, an advertisement format, content and/or audience metadata), each predicted engagement score, in the set of predicted engagement scores, corresponding to a particular target parameter in a set of target parameters.

For example, for each web resource in the corpus of web resources, the computer system can: access a set of historical viewership data in Block S170; estimate a projected viewership based on the set of historical viewership data in Block S171; derive a sentiment for the web resource based on the set of language signals extracted from content within the web resource in Block S174; and annotate the web resource with the projected viewership and the sentiment in Block S175.

Based on the set of engagement scores (e.g., the engagement score, the projected viewership), the computer system can derive insights representing performance of advertising content presented within this ad slot. The computer system can then repeat methods and techniques as described herein for each ad slot in the host of ad slots affiliated with the publisher to derive a corpus of predicted engagement scores representing predicted performance of each ad slot, in the host of ad slots, according to each target parameter in the set of target parameters.

In one implementation, the computer system can then implement an engagement prediction model (or "performance model") (e.g., a large-language model) to predict user engagement with advertising content presented in a particular ad slot on a web resource, in the set of web resources. In particular, the computer system can generate (e.g., “train”) an engagement prediction model (or "performance model") based on: historical engagement data (e.g., clicks, hovers, scroll-events, scroll depths, dwell time) associated with ad slots across web resources; ad creatives represented within these ad slots; and/or ad slot placement within the web resource.

For example, the computer system can implement the engagement prediction model to output a probability that a user will engage with advertising content — rendered within this particular advertisement slot — according to a particular target outcome (e.g., VCR, CTR, viewability) when served this ad. In one example, the engagement prediction model can define a “click-through” target outcome, wherein the engagement prediction model is configured to intake a series of historical engagement data — collected for this particular advertisement slot on the webpage — and output a probability that a user will click on advertising content presented within this particular advertisement slot. Additionally or alternatively, in another example, the engagement prediction model can define a “viewability” target outcome, wherein the engagement prediction model is configured to output a probability that a user will scroll down to advertising content inserted into this advertisement slot and/or that a minimum proportion of this advertising content will be rendered on the user’s computing device (e.g., for at least a minimum duration).

Accordingly, the computer system can leverage the publisher and/or the web resource engagement profile to automatically construct (or “learn”) an engagement prediction model configured to predict user interactions with advertising content presented in the corpus of ad slots defined by the publisher and compile these engagement predictions into a web resource container associated with each web resource in a set of web resources associated with a particular publisher. Therefore, the computer system can: leverage historical engagement data to construct (and/or “teach”) an engagement prediction model to output a set of predicted engagement scores representing target engagements for future ad performance across these web resources; and augment a web resource container (or profile) with these predicted engagement scores.

### 4. Biddable Objects

Generally, the computer system can access a set of biddable objects representing motifs identified across a set of clusters of web resources and purchasable by an advertiser. In particular, the computer system can define a biddable object (i.e., a discrete purchasable concept corresponding to a cluster of web resources) representing a single concept (e.g., “Caitlin Clark”) that functions as a unit of purchase within the ad inventory database. In one example, the computer system maps multiple representations of a single real-world entity to a single biddable object (e.g., “CL16” maps to the biddable object representing “Charles Leclerc”).

In one implementation, the computer system can receive a list of pre-generated biddable objects defined by an operator. In this implementation, the computer system can: define the set of biddable objects based on the list of pre-generated biddable objects; and, for each biddable object in the set of biddable objects, define a target motif associated with the biddable object. Additionally or alternatively, the operator can provide each biddable object in the list of pre-generated biddable objects pre-associated with a corresponding target motif. In one variation, the computer system can derive additional target motifs based on motifs represented in the corpus of web resources.

In one implementation, the computer system can generate the set of biddable objects based on a set of search trend data representing frequency of internet searches during a target time window. In particular, the computer system can: access search data representing internet-wide searches; derive search trends based on the search data; define a set of concepts represented in the search trend data; calculate a frequency of search queries for each concept; select a subset of concepts, each exhibiting a frequency of search queries exceeding a threshold frequency; and derive the set of biddable objects based on the subset of concepts.

In another example, the computer system can identify clusters of web resources in the corpus of web resources based on target motifs associated with each biddable object. For instance, for a biddable object representing a popular sports player, the computer system can define a target motif including: a name of the sports player; a team associated with the sports player; a jersey number; brands associated with the sports player; and activities associated with the sports player. For each web resource in the corpus of web resources, in response to detecting a tag of the web resource corresponding to a target motif in the set of target motifs, the computer system can annotate a cluster of web resources representing the biddable object with the web resource.

In one implementation, the computer system can generate the set of biddable objects based on the corpus of web resources indexed in the ad inventory database. In particular, the computer system can: identify a set of motifs represented across the corpus of web resources; calculate a frequency of occurrence for each motif based on a count of web resources associated with the motif; select a subset of motifs each exhibiting a frequency of occurrence exceeding a threshold frequency; and define the set of biddable objects based on the subset of motifs. Accordingly, the computer system can generate a set of biddable objects grounded in concepts actively represented across the indexed corpus, such that each biddable object corresponds to a motif for which sufficient web resource inventory exists within the ad inventory database.

In one implementation, the computer system can continuously update each biddable object with new web resource inventory. In particular, the computer system can implement methods and techniques as described herein to: access newly published web resources; and characterize motifs of these web resources, such that newly published web resources exhibiting motifs corresponding to a biddable object are integrated into the corresponding cluster of web resources.

In one implementation, the computer system can aggregate biddable objects exhibiting a viewership volume (e.g., viewership traffic, ad slot engagement) falling below a threshold viewership volume into a parent biddable object. For example, during the first time period and for each biddable object in the set of biddable objects, the computer system can: aggregate historical viewership traffic across web resources in the cluster of web resources associated with the biddable object; and estimate a reach score for the biddable object associated with the cluster of web resources based on aggregate projected viewership across web resources in the cluster of web resources. In response to the reach score falling below a threshold reach score, the computer system can: identify a second biddable object in the set of biddable objects exhibiting correspondence to web resources in the cluster of web resources associated with the biddable object in Block S176; augment a second cluster of web resources associated with the second biddable object with web resources in the cluster of web resources associated with the biddable object in Block S177; and remove the biddable object from the set of biddable objects in Block S178.

Additionally or alternatively, the computer system can aggregate biddable objects into a parent biddable object based on an abstraction level of these biddable objects. For example, the computer system can: access a list of biddable objects; for each biddable object in the list of biddable objects, derive an abstraction level of a concept represented by the biddable object; and identify a subset of biddable objects exhibiting an abstraction level falling below a threshold abstraction level. For each biddable object in the subset of biddable objects, the computer system can: calculate a correlation between the biddable object and a parent biddable object (e.g., biddable objects in the list of biddable objects and excluded from the subset of biddable objects); and, in response to the correlation exceeding a threshold correlation, aggregate the biddable object into a parent biddable object container.

Accordingly, the computer system can derive suitability of a concept for representation as a biddable object based on predicted traffic and/or an abstraction level associated with the concept; and, in response to predicted traffic falling below a threshold traffic level and/or the abstraction level exceeding a threshold abstraction level, identify a parent biddable object exhibiting a threshold correlation with the biddable object and aggregate web resources associated with the biddable object into a parent biddable object container.

Therefore, the computer system can: define a set of biddable objects, each biddable object representing a discrete purchasable concept grounded in motifs exhibited across the indexed corpus of web resources; continuously update each biddable object with newly published web resources as they are indexed into the ad inventory database; and automatically filter the set of biddable objects by aggregating concepts exhibiting insufficient traffic volume and/or abstraction level into parent biddable object containers, such that each biddable object represented in the ad inventory database corresponds to a target volume of web resource inventory.

### 4.1 Clusters of Web Resources

Generally, the computer system can define a cluster of web resources based on correspondence between motifs associated with these web resources such that the cluster of web resources represent a particular biddable object. In particular, the computer system can: identify a first web resource associated with a first motif in a set of motifs associated with a biddable object; identify a second web resource associated with a second motif in the set of motifs associated with the biddable object; define a first cluster (e.g., container) of web resources representing the biddable object; and aggregate the first web resource and the second web resource into the first cluster of web resources representing the biddable object.

In one implementation, the computer system can identify a set of motifs for a particular web resource. The computer system can: access a target motif associated with each biddable object in the set of biddable objects; and assign (e.g., aggregate) the web resource into a cluster of web resources representing a particular biddable object based on correspondence between the set of motifs and the set of target motifs.

In one implementation, the computer system can: identify a set of motifs for a particular web resource, the set of motifs including a first motif (e.g., “sports”) and a second motif (e.g., “World Cup”); aggregate a first representation of the web resource into a first cluster associated with the first motif; and aggregate a second representation of the web resource into a second cluster associated with the second motif.

In one implementation, the computer system can calculate a motif confidence score (or "relevance weight") for each web resource in a particular cluster, the motif confidence score (or "relevance weight") — representing a correlation (e.g., strength, prevalence) between themes present within the web resource and the motif. In particular, the computer system can: calculate a set of correlations between each language concept, in a set of language concepts extracted from the web resource, and a first motif, in the corpus of motifs; and calculate a motif confidence score (or "relevance weight") based on the set of correlations. The computer system can then associate the web resource with the motif in response to a subset of correlations exceeding a threshold correlation and/or in response to the motif confidence score (or "relevance weight") exceeding a threshold confidence score.

In one implementation, the computer system can annotate each cluster of web resources with a set of aggregate scores — including an engagement score, a sentiment score, and/or a projected viewership — derived from web resources in the cluster.

For example, for each biddable object in the set of biddable objects, the computer system can: detect a set of ad slots in each web resource in the cluster of web resources associated with the biddable object; calculate an engagement score for ads served to the set of ad slots based on historical traffic across the web resource; annotate the web resource with the engagement score; and calculate a composite engagement score for the biddable object based on aggregate engagement scores across each web resource in the cluster of web resources. The computer system can then present the set of candidate target biddable objects, ranked by composite engagement score, via the ad inventory database in response to a user prompt.

The computer system can implement the methods and techniques described herein for each web resource in the corpus of web resources. Accordingly, the computer system can generate a set of clusters of web resources for a corpus of web resources associated with a set of publishers, such that, in response to a user request for a particular biddable object, the computer system can present clusters of web resources characterized by the particular biddable object and associated motifs, ranked by engagement score.

### 4.2 Prospective Biddable Objects

In one variation, the computer system can define a set of prospective biddable objects representing future events. In particular, the computer system can, for each future event in a set of future events projected to occur during a future time window, access a set of candidate outcomes associated with the future event. Then, for each outcome in the set of candidate outcomes, computer system can: based on historical content generation and consumption data for historical events corresponding to the future event, estimate a predicted content volume for content related to the future event during a future time window succeeding the future event; based on historical viewership traffic associated with historical outcomes corresponding to the outcome, estimate a predicted reach score, representing prospective viewership of content related to the future event; based on historical realized outcomes for past events corresponding to the future event, calculate an outcome probability for the outcome; and define a prospective biddable object, in a set of prospective biddable objects, representing the outcome, the prospective biddable object characterized by the predicted content volume, the predicted reach score, and the outcome probability.

In particular, the computer system can: access event data (e.g., odds, projected outcomes) associated with the future event; and define the set of candidate outcomes accordingly. For each candidate outcome, the computer system can define a corresponding prospective biddable object representing the outcome. Then, for each prospective biddable object, the computer system can: calculate an outcome probability based on the event data; estimate a predicted web resource inventory corresponding to the prospective biddable object based on historical coverage of analogous outcomes; and calculate a predicted reach score based on the predicted web resource inventory weighted by the outcome probability.

Additionally or alternatively, the computer system can define prospective biddable objects based on events predicted to generate high user interest. For example, the computer system can: query a large language model for topics predicted to generate user interest during the future time window in Block S186; and access a set of future events projected to occur during the future time window output by the large language model in Block S187.

The computer system can further assign a prospective value to each prospective biddable object proportional to the predicted reach score and the outcome probability. In particular, the computer system can: estimate a predicted content volume for content related to the future event during a future time window succeeding the future event based on historical content generation and consumption data for historical events corresponding to the future event; estimate a predicted reach score, representing prospective viewership of content related to the future event based on historical viewership traffic associated with historical outcomes corresponding to the outcome; calculate an outcome probability for the outcome based on historical realized outcomes for past events corresponding to the future event; and characterize the biddable object by the predicted content volume, the predicted reach score, and the outcome probability.

In one implementation, the computer system can generate a set of ad campaign offers corresponding to the set of prospective biddable objects. In particular, for each prospective biddable object, the computer system can package the predicted web resource inventory, the predicted reach score, the outcome probability, and an assigned price into an ad campaign offer. The computer system can then present the set of ad campaign offers via an advertiser portal (i.e., a user interface) and receive selection of a first prospective biddable object by a first advertiser prior to occurrence of the future event.

In one variation, the computer system can generate the set of prospective biddable objects based on historical event data derived from the corpus of web resources. In particular, the computer system can: identify historical event data based on the corpus of web resources; define a set of prospective biddable objects based on an event prediction model and the historical event data; and characterize each prospective biddable object in the set of prospective biddable objects with an outcome probability based on the historical event data.

Additionally or alternatively, the computer system can generate the set of prospective biddable objects based on events projected to derive high user interest during future time windows. In particular, the computer system can: query a large language model for topics predicted to generate user interest during the future time window; and access the set of future events projected to occur during the future time window output by the large language model. Accordingly, in this variation the computer system can offload future event detection to a remote large language model.

Additionally or alternatively, the computer system can receive a prompt from a user describing a desired prospective outcome (e.g., a sports team winning a championship game in three months). The computer system can then: implement natural language processing methods to derive a target prospective biddable object; identify a set of prospective biddable objects associated with the target prospective biddable object — such as a prospective biddable object representing the sports team and a prospective biddable object representing a sports league associated with the sports team; leverage historical data associated with the set of prospective biddable objects — such as prior web resource coverage of the analogous event in prior years — to estimate a predicted web resource inventory representing an estimated count of web resources associated with the target prospective biddable object; calculate an outcome probability for the target prospective biddable object based on the historical data; and calculate a predicted reach score based on the predicted web resource inventory weighted by the outcome probability. The computer system can then package the target prospective biddable object into an ad campaign offer characterized by the predicted web resource inventory and the predicted reach score.

In one variation, the computer system can update prospective values of prospective biddable objects based on newly published web resources. In particular, the computer system can: access a corpus of newly published web resources; for each newly published web resource in the corpus of newly published web resources, extract a set of language signals from the content of the newly published web resource and derive a motif based on the language signals; and, in response to the motif corresponding to a candidate outcome of a future event in the set of future events, recalculate an outcome probability for the candidate outcome.

For example, in advance of a major sporting event, the computer system can: continuously query sources for newly published web resources associated with the major sporting event; recalculate outcome probabilities for each candidate outcome based on emerging signals; and update prospective values of corresponding prospective biddable objects, such that advertiser-facing prices reflect the latest available event data throughout a pre-event period.

Therefore, the computer system can: represent candidate outcomes of future events as prospective biddable objects (e.g., purchasable objects of advertising inventory) in the ad inventory database, enabling advertisers to acquire rights to web resource inventory before such inventory exists; dynamically value each prospective biddable object based on continuously updated outcome probabilities derived from newly published web resources, such that prospective biddable objects are characterized by current event data; and automatically activate purchased prospective biddable objects based on realized outcomes upon event resolution by associating web resource inventory with advertisers who purchased rights in advance, without requiring manual operator intervention.

### 4.3 Dynamic Biddable Objects

In one implementation, the computer system can generate custom (or “new”) biddable objects responsive to user requests for particular biddable objects excluded from a list of pre-defined biddable objects.

In one implementation, the computer system can derive a target biddable object based on a natural language prompt input by the user at the user interface. In particular, the computer system can: access a natural language prompt defining a custom concept, theme, or targeting constraint; extract user-defined motifs from the prompt; and generate a custom biddable object based on matching web resources to the user-defined motifs. In one variation, the computer system can combine user-defined motifs with system-generated motifs and/or existing biddable objects.

In particular, the computer system can tag web resource inventory in real time responsive to receiving a user request for a particular biddable object excluded from the list of pre-defined biddable objects. For example, the computer system can implement methods and techniques as described herein to: derive a target biddable object from the user input; access the corpus of web resources; extract language concepts and content signals from the web resources; and implement methods and techniques as described herein to identify a subset (or “cluster”) of web resources exhibiting motifs corresponding to the target biddable object.

In one variation, the computer system can generate a dynamic biddable object, such as in response to receiving a prompt from a user for a target biddable object excluded from the set of biddable objects. In particular, the computer system can: receive a prompt from a user; extract a set of language signals from the prompt; and derive a dynamic biddable object based on the set of language signals. In response to detecting absence of the dynamic biddable object in the set of biddable objects, the computer system can define a target motif associated with the dynamic biddable object. The computer system can then implement methods and techniques as described herein to identify web resources associated with the target motif. For example, for each web resource in the corpus of web resources, the computer system can: access a set of tags associated with the web resource; and, in response to a tag corresponding to the target motif, select the web resource for generation of a dynamic cluster of web resources associated with the dynamic biddable object. In particular, the computer system can aggregate the selected web resources into the dynamic cluster of web resources corresponding to the target motif. The computer system can then define the dynamic biddable object based on the dynamic cluster of web resources, such that the dynamic biddable object represents a set of web resources associated with the target concept defined by the prompt.

In one variation, the computer system can implement methods and techniques as described herein to generate dynamic and/or custom prospective biddable objects. For example, the computer system can derive a target prospective biddable object excluded from the set of prospective biddable objects. In response to detecting absence of the target biddable object in the set of prospective biddable objects, the computer system can: identify a target future event associated with the target biddable object; and access a set of target prospective event data representing the target future event and a set of target candidate outcomes associated with the target future event. The computer system can then, for each outcome in the set of target candidate outcomes: calculate an outcome probability for the outcome based on the set of target prospective event data; calculate a predicted reach score for prospective web resources associated with the outcome; characterize the outcome based on the outcome probability and the predicted reach score; and define a target prospective biddable object, in a set of target prospective biddable objects, representing the outcome. The computer system can then present the set of target prospective biddable objects via the user interface.

Accordingly, the computer system can dynamically construct biddable objects — including prospective biddable objects representing candidate outcomes of future events — in response to user-defined prompts, without requiring pre-definition of the biddable object in the set of biddable objects. Therefore, the computer system can: enable advertisers to define and purchase against any concept, theme, or targeting constraint, regardless of whether a corresponding biddable object exists in the pre-defined set; and extend on-demand biddable object generation to prospective inventory, enabling advertisers to define and purchase rights to custom future-event inventory that is absent from the pre-defined set of prospective biddable objects — without manual platform operator intervention.

### 5. Supply Search + Ad Campaigns: Text Prompts

Generally, the computer system can: receive a text prompt from a user at an user interface of an ad platform; extract a set of language signals from the text prompt; derive a target biddable object from the set of language signals; select a target cluster of web resources, in the set of clusters of web resources, corresponding to the target biddable object; access a set of object-level attributes of the target biddable object; and render web resources associated with the target biddable object, annotated with the set of object-level attributes, within the user interface for selection by the user.

In particular, the computer system can: receive a text prompt from a user (e.g., an advertiser) at the user interface, the text prompt defining a concept, entity, theme, or campaign objective; extract a set of language signals from the text prompt; derive a target biddable object (e.g., a public figure, an event, a theme) from the set of language signals; and identify a target cluster of web resources associated with the target biddable object across a set of publishers.

The computer system can then access a set of object-level attributes associated with the target cluster of web resources, such as object-level attributes including: a count of web resources in the target cluster of web resources; a distribution of web resources across publishers in the set of publishers; a sentiment distribution representing proportions of web resources, in the target cluster of web resources, exhibiting positive, negative, and neutral sentiments associated with the target biddable object; a predicted availability score representing a predicted total view count across web resources, in the target cluster of web resources, during a target time window; a predicted reach score representing a predicted count of unique viewers across web resources, in the target cluster of web resources, during the target time window; and/or a set of predicted engagement metrics representing predicted interactions with ad slots across web resources in the target cluster of web resources. The computer system can then render the target cluster of web resources, associated with the target biddable object and annotated with the set of object-level attributes, within the ad inventory database for selection by the user.

In one example, the computer system can: derive a set of target metrics from the set of language signals extracted from the text prompt; and automatically filter web resources in the target cluster based on the set of target metrics. In particular, the computer system can: identify a target sentiment (e.g., positive, negative) defined by the text prompt based on the set of language signals; identify a target performance threshold (e.g., minimum viewability score, minimum click-through rate, minimum predicted reach count) defined by the text prompt; and exclude web resources from the target cluster of web resources that fail to satisfy the target sentiment and/or the target performance threshold.

In particular, the computer system can: receive a text prompt representing a constraint for the target biddable object (e.g., viewability threshold, sentiment preference). In response to detecting the constraint in the text prompt, the computer system can: extract the constraint from the set of language signals; interpret the constraint as a filter parameter; apply the filter parameter to web resources in the target cluster of web resources; and dynamically update the set of object-level attributes rendered in the ad inventory database according to the filter parameter.

For example, based on the first set of language signals extracted from the first user prompt, the computer system can: derive a target reach score for the target biddable object in Block S106; and derive a target sentiment for the target biddable object in Block S140. The computer system can then: select the set of candidate biddable objects, each biddable object in the set of candidate biddable objects satisfying the target reach score and associated with web resources corresponding to the target sentiment.

In this example, the computer system can: derive a target sentiment based on the first set of language signals extracted from the first user prompt in Block S140; and identify the set of candidate biddable objects associated with web resources satisfying the target sentiment and the threshold reach score in Block S142.

In the foregoing example, the computer system can additionally, for each candidate biddable object in the set of candidate biddable objects, define a subcluster of web resources satisfying the target sentiment and the threshold reach; and present the set of candidate biddable objects associated with the subcluster of web resources.

For example, for each web resource in a cluster of web resources corresponding to the candidate biddable object, the computer system can: identify a reach score and a sentiment for the candidate biddable object associated with the web resource; in response to the reach score falling below the threshold reach score, exclude the web resource from the subcluster of web resources; and/or, in response to the sentiment for the candidate biddable object failing to satisfy the target sentiment, exclude the web resource from the subcluster of web resources.

Accordingly, the computer system can: interpret constraints represented in natural language; and automatically apply those constraints to the target cluster of web resources without requiring the user to separately configure filter parameters via the user interface.

Additionally or alternatively, the computer system can: render filter parameters within the user interface; receive user selection of a particular filter parameter; and automatically filter web resources presented in the user interface according to the particular filter parameter.

In one variation, the computer system can identify exclusion parameters associated with the user input. In particular, the computer system can identify exclusion parameters from the user prompt and/or based on inputs to the filter parameters rendered on the user interface. For example, the computer system can: receive selection of a first biddable object, in the set of candidate biddable objects, by the user in Block S152; and, in response to receiving an exclusion input corresponding to a publisher associated with web resources in a first cluster of web resources associated with the first biddable object: define a subcluster of web resources, associated with the first biddable object, excluding web resources published by the publisher in Block S122.

In another example, in response to receiving an exclusion input corresponding to a first web resource in a first cluster of web resources associated with the first biddable object, the computer system can: define a subcluster of web resources, associated with the first biddable object, excluding the first web resource in Block S124.

Accordingly, the computer system can automatically filter web resources in clusters of web resources based on inputs by the user.

In another variation, the computer system can extract a set of (e.g., multiple) target biddable objects from a text prompt. In particular, the computer system can: extract a first set of language signals and a second set of language signals from the text prompt; derive a first target biddable object from the first set of language signals; derive a second target biddable object from the second set of language signals; select a first target cluster of web resources corresponding to the first target biddable object; select a second target cluster of web resources corresponding to the second target biddable object; access a first set of object-level attributes for the first target biddable object; access a second set of object-level attributes for the second target biddable object; and render the first target biddable object and the second target biddable object, each annotated with corresponding sets of object-level attributes, within the user interface for selection by the user.

In one example, the computer system can: receive a text prompt defining a set of concepts (e.g., a public figure and an event); extract a target biddable object corresponding to each concept in the set of concepts; select a set of candidate biddable objects from the set of biddable objects based on target biddable objects; for each candidate biddable object in the set of candidate biddable objects, calculate a relevance score representing correspondence between each biddable object and the set of language signals extracted from the text prompt; and render the set of candidate biddable objects within the user interface ranked by corresponding relevance scores.

In one variation, the computer system can implement methods and techniques as described herein to derive candidate prospective biddable objects responsive to a user text prompt. In this variation, the computer system can implement methods and techniques as described herein to filter prospective biddable objects based on target filter parameters (e.g., target reach score, target viewability). In particular, for each outcome in the set of candidate outcomes, the computer system can: access a set of historical viewership traffic associated with historical outcomes corresponding to the outcome; and estimate a prospective reach score, representing prospective viewership of web resources associated with the outcome, based on the set of historical viewership traffic. Then, based on the first set of language signals extracted from the first user prompt, the computer system can derive a target reach score representing target viewership of web resources associated with a target prospective biddable object; and derive the set of candidate prospective biddable objects satisfying the target reach score.

In one variation, the computer system can implement methods and techniques as described herein to generate biddable objects responsive to user text prompts. For example, the computer system can: receive the first user text prompt at the user interface; derive a target biddable object excluded from a set of pre-defined biddable objects; and define a target motif associated with the target biddable object. The computer system can then, for each web resource in the corpus of web resources: implement methods and techniques as described herein to identify motifs associated with the web resource; and, in response to the motif corresponding to a target motif in the set of target motifs, augment a target cluster of web resources including the web resource; and select the target cluster of web resources corresponding to the target biddable object for presentation in the user interface responsive to the first user prompt.

Therefore, in the foregoing implementations, the computer system can filter a corpus of web resources for targeted web resources specific to a user-specific ad campaign based on biddable objects defined within a user prompt to the user interface, to thereby enable a user to select (and/or “bid upon”) objects, represented in the user interface, and automatically gain advertising rights to ad slots across a cluster of related web resources.

### 6. Supply Search + Ad Campaigns: Media Prompts

In one implementation, the computer system can: access a media file (e.g., an image, a video, a multimedia creative, an ad template) uploaded to the user interface by a user (e.g., an advertiser); and, based on a set of features extracted from the media file, identify a set of candidate biddable objects corresponding to the media file. In particular, the computer system can: receive a media file uploaded by a user; detect a text block in the media file; extract a first set of language signals from the text block in the media file; extract a set of features from the media file in Block S148; and identify the set of candidate biddable objects based on the first set of language signals and the set of visual features of the media file in Block S134.

In one implementation, the computer system can identify a candidate biddable object including: a biddable object directly represented in the media file (e.g., a media file featuring a popular soccer player corresponds to a biddable object representing the popular soccer player); and/or a biddable object associated with visual features of the media file (e.g., a media file featuring a basketball player corresponds to a biddable object representing basketball, a media file featuring a soccer ball corresponds to a biddable object representing a soccer league).

In one implementation, the computer system can: access the media file input by the user at the user interface; extract a set of features from the media file, such as visual elements (e.g., logos, products, scenes) and semantic descriptors (e.g., inferred product category, brand, use case, IAB content category); generate a target concept based on the set of features; and generate a search prompt based on the target concept. The computer system can then: map the target concept to a set of candidate biddable objects represented by clusters of web resources semantically aligned with the media file; and present the set of candidate biddable objects to the user via the user interface.

In one implementation, the computer system can rank the set of candidate biddable objects based on: a semantic similarity score representing correspondence between each candidate biddable object and the set of features extracted from the media file; and/or a set of predicted campaign performance metrics associated with each candidate biddable object. The computer system can then render the set of candidate biddable objects, ranked by the semantic similarity score and/or the set of predicted campaign performance metrics, within the user interface for selection by the user.

In one variation, the computer system can: infer a target audience based on the set of features extracted from the media file; and identify candidate biddable objects based on the target audience. In particular, the computer system can: access the set of features extracted from the media file; infer a set of audience attributes representing characteristics (e.g., demographic characteristics, interest categories, behavioral patterns) of users likely to engage with the media file; and identify a set of candidate biddable objects corresponding to clusters of web resources predicted to be viewed by the target audience based on the set of audience attributes. The computer system can then render the set of candidate biddable objects, identified based on the target audience, within the user interface for selection by the user. Accordingly, the computer system can identify candidate biddable objects based on audience correspondence — rather than semantic correspondence between the media file and web resource content — thereby enabling the user to identify advertising inventory aligned with the audience for the media file.

### 7. Supply Search + Ad Campaigns: URL Prompts

In another implementation, the computer system can: access a uniform resource locator (e.g., a URL corresponding to a product website or an advertiser website) input by a user (e.g., an advertiser) at the user interface; access a webpage via the uniform resource locator; extract a set of features from the webpage; and, based on the set of features, identify a set of candidate biddable objects corresponding to the uniform resource locator.

In particular, the computer system can: receive (e.g., access) a uniform resource locator, corresponding to a catalog of products associated with an advertiser, at the user interface in Block S190; access a set of product descriptions of products in the catalog of products via the uniform resource locator in Block S191; extract a first set of language signals from the set of product descriptions in Block S192; extract a set of features from the catalog of products via the uniform resource locator in Block S179; and derive a set of candidate biddable objects based on the first set of language signals and the set of features of the catalog of products in Block S136.

In one implementation, the computer system can identify the candidate biddable objects, including biddable objects corresponding to themes, entities, or events represented within the web resource, such as biddable objects corresponding to products available for purchase at the uniform resource locator. In particular, the computer system can: access the uniform resource locator input by the user at the user interface; access a webpage via the uniform resource locator; and extract a set of content signals from the webpage, such as including textual content (e.g., contiguous sequences of words, entities, phrases), embedded media (e.g., images, video), and/or metadata associated with the webpage. The computer system can then: derive a target concept representing themes, entities, or events present within the web resource based on the set of content signals; generate a search prompt based on the target concept; and supply the search prompt to the user interface. In particular, the computer system can: derive a set of language signals from the search prompt; derive a target biddable object from the set of language signals; select a target cluster of web resources, in the set of clusters of web resources, corresponding to the target biddable object; and present the target biddable object within the user interface for selection by the user.

In one variation, the computer system can implement methods and techniques described herein to identify a set of candidate biddable objects based on product descriptions of products in a catalog of products displayed for purchase at the uniform resource locator. In particular, the computer system can: access the web resource via the uniform resource locator; and extract a set of product information (e.g., product names, product attributes, product descriptions, product categories, product attributes) from the webpage. The computer system can then: map the set of product information to a target concept; derive a target biddable object from the target concept; and select a target cluster of web resources corresponding to the target biddable object. Accordingly, the computer system can identify candidate biddable objects and corresponding clusters of web resources aligned with specific products available for purchase at the uniform resource locator — thereby enabling the user to identify advertising inventory aligned with specific products and construct ad campaigns targeting web resources relevant to those products.

Additionally or alternatively, the computer system can implement methods and techniques as described herein to identify a target biddable object based on a predicted audience associated with products represented for purchase at the uniform resource locator. For example, the computer system can: access the set of product information; infer a set of audience attributes representing characteristics (e.g., demographic characteristics, interest categories, behavioral patterns) of users likely to engage with products based on the set of product information; and identify a set of candidate biddable objects corresponding to clusters of web resources that over-index for the target audience based on the set of audience attributes. The computer system can then render the set of candidate biddable objects, identified based on the target audience, within the user interface for selection by the user. Accordingly, the computer system can identify candidate biddable objects based on audience correspondence, rather than semantic correspondence between the media file and web resource content, thereby enabling the user to identify advertising inventory aligned with the audience for products in the catalog of products.

### 8. Advertiser Confirmation + Ad Slot Identification

Generally, the computer system can: receive selection (e.g., confirmation, purchase) of a particular biddable object by an advertiser; and assign and/or allocate advertising rights of ad slots on web resources in a particular cluster of web resources — associated with the particular biddable object — to the advertiser. In particular, in response to detecting selection of a target biddable object, in the set of candidate biddable objects, the computer system can, at instances of web resources, in a target cluster of web resources associated with the target biddable object, allocate ad slots to ad content supplied by the user.

In one implementation, the computer system can: present a set of target biddable objects to a set of advertisers via the user interface; and receive a set of bids from advertisers competing for advertising rights on web resources associated with the target biddable object. In one implementation, the computer system can: receive a set of bids from a set of advertisers; identify a winning bid (e.g., a greatest bid) in the set of bids; and, in response to identifying the winning bid, assign advertising rights of ad slots across the target cluster of web resources to the advertiser associated with the winning bid for a target campaign window (e.g., seven days, thirty days). In one variation, the computer system can implement a fixed-price model (i.e., a pre-set purchase price defined by the platform) for biddable objects, such that a first advertiser to confirm purchase of the target biddable object at the fixed price is assigned advertising rights of the target cluster of web resources.

In one implementation, in response to detecting selection of the target biddable object, the computer system can: access a first digital ad (e.g., uploaded by the advertiser) in Block S150; and associate the first digital ad with each web resource in the target cluster of web resources. The computer system can then, at a first instance of a first web resource, in the target cluster of web resources, rendered by a computing device: detect a contiguous series of words representing a first language signal corresponding to the target biddable object in Block S154; and insert the first digital ad into a first ad slot proximal the contiguous series of words in Block S158.

Additionally or alternatively, the computer system can allocate advertising rights to a subset of web resources in the cluster of web resources associated with a particular biddable object selected by an advertiser.

For example, the computer system can allocate advertising rights to a subset of web resources – exhibiting a target reach score and/or sentiment – in the cluster of web resources associated with a particular biddable object selected by an advertiser.

In particular, in this example, the computer system can: define a subcluster of web resources satisfying the target sentiment and the threshold reach score; and allocate ad slots to ad content supplied by the user at instances of web resources, in a target subcluster of web resources, associated with the target biddable object.

Additionally or alternatively, the computer system can allocate advertising rights to a subset of web resources – excluding particular web resources associated with an excluded publisher and/or explicitly excluded by the advertiser – in the cluster of web resources associated with a particular biddable object selected by an advertiser. In particular, in this example, the computer system can: define a subcluster of web resources, associated with the first biddable object, excluding web resources published by the publisher in Block S122; and allocate ad slots to ad content supplied by the user at instances of web resources in the subcluster of web resources.

Additionally or alternatively, in this example, in response to receiving an exclusion input corresponding to a first web resource in a first cluster of web resources associated with the first biddable object, the computer system can: define a subcluster of web resources, associated with the first biddable object, excluding the first web resource in Block S124; and allocate ad slots to ad content supplied by the user at instances of web resources in the subcluster of web resources.

Accordingly, the computer system can couple the outcome of a bidding process to the allocation of advertising rights across a target cluster of web resources, such that an advertiser associated with a winning bid receives exclusive ad slot access across every web resource in the cluster of web resources for the duration of the target campaign window.

Therefore, the computer system can implement a biddable object auction to: allocate advertising rights of ad slots across the target cluster to a winning advertiser; and insert digital ads associated with the winning advertiser into ad slots proximal the language signals — within rendered web resources in the target cluster — that correspond to the purchased biddable object.

### 8.1 Prospective Biddable Objects: Advertiser Confirmation + Ad Slot Identification

In one implementation, in response to receiving selection of a first prospective biddable object, in the set of prospective biddable objects, by a first advertiser, the computer system can allocate advertising rights of prospective ad slots associated with the first prospective biddable object to the first advertiser. In one example, the computer system can: receive selection of a prospective biddable object representing a first candidate outcome of a future sporting event (e.g., a first team winning a championship) by a first advertiser prior to occurrence of the event; and allocate advertising rights of prospective ad slots, across the predicted cluster of web resources associated with the first candidate outcome, to the first advertiser, such that the first advertiser holds pre-purchased rights to ad slots in web resources projected to cover the first candidate outcome.

In particular, during a third time period following occurrence of the future event, the computer system can: identify a realized outcome of the future event in Block S185; and, in response to the realized outcome corresponding to the first prospective biddable object, access a second corpus of web resources published between the target time window and the third time period. For each web resource in the second corpus of web resources, the computer system can: extract a set of language signals from content within the web resource; derive a motif of the web resource based on the set of language signals; and, in response to the motif representing the realized outcome, associate the web resource with the first prospective biddable object. The computer system can then: detect a set of ad slots in the web resource; access ad content associated with the first advertiser and the first prospective biddable object; and insert the ad content into the set of ad slots.

In one variation, the computer system can: receive selection of a second prospective biddable object, in the set of prospective biddable objects, by a second advertiser during the first time period; and, during the third time period following occurrence of the future event and in response to the realized outcome differing from the second prospective biddable object, withhold association of web resources in the second corpus of web resources with the second prospective biddable object in Block S188 and withhold insertion of digital ads associated with the second advertiser into web resources associated with the future event in Block S189.

Accordingly, the computer system can monitor newly published web resources following occurrence of the future event and, in response to detecting instances of motifs corresponding to a realized outcome previously selected by an advertiser, automatically insert ad content associated with the advertiser into web resources associated with the realized outcome, to enable pre-event allocation of advertising inventory tied to prospective outcomes and automatic post-event activation of ad campaigns.

Therefore, the computer system can implement prospective biddable objects to enable advertisers to secure concept-level advertising rights — tied to candidate outcomes of future events — prior to occurrence of those events, and to automatically activate or withhold ad campaigns across newly published web resources based on whether the realized outcome corresponds to the purchased biddable object.

### 8.2 Variation: Closed-Loop Dynamic Filtering

In one variation, the computer system can adapt the sourcing criteria of a biddable object based on a sequence of content exclusion actions applied by an advertiser to the cluster of web resources associated with the biddable object. In one example, the computer system can: monitor a sequence of content exclusion actions — such as removal of web resources of a particular content category, domain, or sentiment classification — applied by the advertiser to the cluster of web resources; and derive an exclusion pattern from the sequence of content exclusion actions. The computer system can then apply the exclusion pattern to the sourcing criteria of the biddable object, such that web resources matching the exclusion pattern are filtered from subsequent additions to the cluster of web resources. Accordingly, the computer system can refine the composition of a biddable object over time in response to inferred advertiser preferences, without requiring the advertiser to apply explicit exclusion criteria to each web resource added to the cluster of web resources following derivation of the exclusion pattern.

### 9. Transient Ad Slots

In one implementation, the computer system can: generate a transient ad slot (i.e., a dynamic ad slot generated at render time rather than pre-defined in a page layout) proximal a contiguous series of words — identified as a content signal corresponding to a target biddable object — within a body of a web resource; and insert a digital ad associated with an advertiser into the transient ad slot.

In particular, at a first instance of a first web resource, in the target cluster of web resources, rendered by a computing device, the computer system can: detect a first contiguous series of words representing a first language signal corresponding to the target biddable object in Block S127; generate a transient ad slot proximal the first contiguous series of words in Block S156; insert a first digital ad into the transient ad slot in Block S158; and, in response to a first scroll event locating the first contiguous series of words within a viewing window of the computing device, render the first digital ad within the transient ad slot in Block S160.

In one implementation, the computer system can: scan a body of a web resource for a set of content signals (i.e., contiguous words or phrases representing concepts associated with a target biddable object); associate each content signal in the set of content signals with a motif of the web resource; identify a subset of content signals, in the set of content signals, as candidate locations for transient ad slot generation; and generate a transient ad slot proximal each candidate location in the subset of content signals. In one example, the computer system scans the body of a news article covering a product launch, identifies a set of phrases referencing the product — such as the product name, a feature descriptor, and a release date mention — as content signals corresponding to a target biddable object representing the product, and generates a transient ad slot immediately following the first such phrase encountered in the article body, such that a digital ad associated with the advertiser renders in direct editorial proximity to the content signal that prompted the advertiser to purchase the biddable object in the first instance.

In one implementation, the computer system can identify candidate content signal locations based on advertiser-defined targeting parameters. In particular, the computer system can: access a set of advertiser profiles, each advertiser profile including a set of pre-defined content signals representing target concepts, keywords, or phrases associated with the advertiser's campaign; extract the set of pre-defined content signals from a first advertiser profile; scan the body of the web resource for instances of the set of pre-defined content signals; and, in response to detecting a match between a pre-defined content signal and a phrase in the body of the web resource, designate the matching phrase as a candidate location for transient ad slot generation. The computer system can then aggregate the set of candidate locations into a set of tags characterizing the web resource, such that the web resource is retrievable by the ad inventory database in response to a query for inventory matching the advertiser's predefined content signals.

In one variation, the computer system can define a set of exclusion zones — such as a title of the web resource, a subtitle, image captions, and ancillary navigational text — and confine candidate location identification to the body of the web resource, excluding these zones from transient ad slot generation. In this variation, in response to detecting multiple instances of the same content signal within the body of the web resource, the computer system can select a first instance of the content signal — defined as the instance appearing earliest in the body of the web resource — as the candidate location, such that no more than one transient ad slot is generated per content signal across the web resource. In response to detecting multiple distinct content signals within the body of the web resource, the computer system can: select a first candidate location within a first viewport (i.e., the visible portion of the web resource rendered within a first scroll position of the device); and select a second candidate location within a second viewport distinct from the first viewport, such that the transient ad slots generated at the first and second candidate locations are not simultaneously visible to the user within a single rendered window of the web resource.

Therefore, the computer system can generate transient ad slots at candidate locations — identified within the body of a web resource based on motif-aligned content signals and advertiser-defined targeting parameters — to place digital ads in direct editorial proximity to the phrases that establish the contextual relevance of the web resource to the purchased biddable object, while distributing ad placements across distinct viewports to maximize viewability across a browsing session.

### 10. Search Objects + Ephemeral Ad Slots

In one implementation, the computer system can define a search biddable object (i.e., a biddable object defined by a predicted search query rather than a cluster of existing web resources) and present the search biddable object to advertisers via the user interface. In particular, the computer system can define a search biddable object associated with web resources that do not exist at the time of purchase, such that an ephemeral webpage corresponding to a search biddable object is dynamically generated and in real time responsive to a user submitting a search query for the search biddable object.

In one example, the computer system can derive a set of biddable objects representing prospective search queries. For each biddable object in the set of biddable objects, the computer system can: define a set of search queries corresponding to the biddable object; calculate a query probability representing a likelihood of a user inputting a search query in the set of search queries; characterize the biddable object based on the predicted engagement score and the query probability; and serve the set of biddable objects to a user interface.

In one implementation, the computer system can: access a set of predicted search queries representing a target concept; group subsets of search queries under a search biddable object based on semantic correspondence between each search query and the target concept such that queries of varying specificity are each associated with a single search biddable object representing the target concept; and calculate a predicted query volume for the search biddable object based on historical search frequency data associated with the set of search queries. The computer system can then present the search biddable object — annotated with the predicted query volume and a predicted engagement score derived from historical ad performance data associated with analogous search queries — to advertisers via the user interface.

Then, during a second time period succeeding the first time period, the computer system can implement methods and techniques as described herein to: access and/or receive a first user prompt at the user interface; extract a first set of language signals from the first user prompt; derive a set of candidate biddable objects based on the first set of language signals; and present the set of candidate biddable objects via the user interface and responsive to the first user prompt.

In one implementation, the computer system can receive a maximum bid price representing a maximum amount that an advertiser is willing to pay per impression or per thousand impressions (e.g., a maximum CPM) for ad slots on ephemeral webpages for the search biddable object. In response to a user submitting a search query associated with the search biddable object, the computer system can: generate an ephemeral webpage responsive to the search query; execute a per-impression auction among advertisers associated with max bid prices for the search biddable object; identify a winning advertiser based on the max bid price; and inject a digital ad associated with the winning advertiser into an ad slot on the ephemeral webpage.

For example, during a third time period succeeding the second time period and in response to detecting selection of a first biddable object, in the set of candidate biddable objects, by an advertiser associated with the user prompt, via the user interface, the computer system can detect a first search query at a publisher webpage.

In response to detecting correspondence between the first search query and the first biddable object, the computer system can then: identify a first ad slot on an ephemeral webpage associated with the first search query; and insert a first digital ad, associated with the advertiser, into the first ad slot.

In another variation, in response to detecting selection of a first biddable object, in the set of candidate biddable objects, by an advertiser, associated with the user prompt, via the user interface, the computer system can implement methods and techniques as described herein to inject a product carousel on an ephemeral webpage.

In particular, in this variation, the computer system can access a catalog of products associated with the advertiser in Block S190. For each product in the catalog of products, the computer system can: access a product description of the product in Block S191; extract a set of language signals from the product description in Block S192; and calculate a correlation between the product and the first biddable object based on the set of language signals in Block S194. The computer system can then detect a set of products, in the catalog of products, each product in the set of products exhibiting correlations between the product and the first biddable object exceeding a threshold correlation in Block S196.

At an instance of an ephemeral webpage associated with a search query corresponding to first biddable object, the computer system can: detect an ad slot in the web resource in Block S198; and insert a representation of each product in the set of products into the ad slot in Block S199.

The computer system can repeat methods and techniques as described herein for each search query associated with the search biddable object, such as until a total spend associated with the winning advertiser reaches the advertiser's campaign budget.

In one variation, the computer system can: extract a set of language signals from a search query submitted by a user; derive a target concept from the set of language signals; and, in response to the target concept corresponding to a purchased search biddable object, execute a per-impression auction as described above and inject a digital ad associated with the winning advertiser into an ad slot on the ephemeral webpage. In response to the target concept falling outside the semantic scope of any purchased search biddable object, the computer system can withhold injection of a digital ad on the ephemeral webpage.

In another variation, the computer system can detect overlap between search biddable objects, such as in response to a search query corresponding to a set of purchased search biddable objects; and execute an auction among the advertisers associated with (e.g., purchased) the set of purchased search biddable objects to thereby allocate the ad slot on the ephemeral webpage to a first advertiser associated with a digital ad projected to yield a highest return for the publisher, such as based on predicted click-through rate, predicted viewability, and/or max bid price.

Therefore, the computer system can define search biddable objects as semantically grouped search queries, dynamically generate ephemeral webpages at user query time, and inject digital ads associated with the winning advertiser into ad slots on those pages to thereby enable advertisers to purchase concept-level advertising rights on web resources that do not exist at the time of purchase and to automatically activate ad campaigns in response to user search behavior, without requiring post-query manual campaign management.

### 11. Ad Rendering

In one implementation, the computer system can associate interactive digital ads (e.g., scroll-responsive ads) with pre-defined ad slots on a web resource. For example, the computer system can: associate a first digital ad with a first web resource in the target cluster of web resources; at a first instance of the first web resource rendered by a computing device, detect a contiguous series of words representing a first language signal corresponding to the target biddable object; insertthe first digital ad into a first ad slot proximal the contiguous series of words; and, in response to a first scroll event, locate the first ad slot within a viewing window of the computing device, thereby presenting the first digital ad within the first ad slot rendered on the computing device.

Additionally or alternatively, the computer system can implement methods and techniques as described herein to associate interactive digital ads (e.g., scroll-responsive ads) with transient ad slots on a web resource. For example, the computer system can associate the first digital ad with each web resource in the target cluster of web resources and, at a first instance of a first web resource in the target cluster of web resources, rendered by a computing device: detect a first contiguous series of words representing a first language signal corresponding to the target biddable object; generate a transient ad slot proximal the first contiguous series of words; insert the first digital ad into the transient ad slot; and, in response to a first scroll event locating the first contiguous series of words within a viewing window of the computing device, render the first digital ad within the transient ad slot.

In particular, in this example, the computer system can: in response to the first scroll event locating the transient ad slot within the viewing window of the computing device, the first contiguous series of words at a first vertical position within the viewing window, render a first frame, in a sequence of frames of the first digital ad, over content in the web resource proximal the first contiguous series of words; and, in response to detecting relocation of the first contiguous series of words from the first vertical position to a second vertical position within the viewing window based on a first scroll-down event, render a second frame, in the sequence of frames of the first digital ad, over content in the web resource proximal the first contiguous series of words, the second frame associated with the second vertical position.

In one variation, the computer system can assemble a digital ad in an ad slot. For example, the computer system can: receive the media file including an ad template from a user; and, in response to detecting selection of the target biddable object by the user, associate the ad template with each web resource in the target cluster of web resources. Then, at a first instance of a first web resource, in the target cluster of web resources, rendered by a computing device, the computer system can: detect a contiguous series of words representing a first language signal corresponding to the target biddable object; detect a first ad slot proximal the contiguous series of words; insert the ad template into the first ad slot; and, in response to a first scroll event locating the first ad slot within a viewing window of the computing device, assemble the ad template into a first digital ad within the first ad slot.

In another variation, the computer system can assemble a digital ad as a product carousel (i.e., a scrollable set of product representations assembled dynamically within an ad slot) including products predicted to perform well with an audience associated with the target biddable object. In particular, in response to detecting selection of the target biddable object by an advertiser, the computer system can: access a product catalog associated with the advertiser; for each product in the product catalog, extract a set of language signals from a product description of the product and calculate a correlation between the product and the target biddable object based on the set of language signals; and identify a set of products, in the product catalog, each product in the set of products exhibiting a correlation with the target biddable object exceeding a threshold correlation. The computer system can then, at an instance of a first web resource in the target cluster of web resources rendered by a computing device: detect an ad slot in the first web resource; and insert a representation of each product in the set of products into the ad slot as a product carousel.

More specifically, the computer system can infer a target audience associated with the target biddable object and identify a subset of products, in the product catalog, predicted to perform well with the target audience. In particular, the computer system can: access a set of audience attributes associated with the target biddable object, the set of audience attributes representing characteristics (e.g., demographic characteristics, interest categories, behavioral patterns) of users likely to engage with web resources in the target cluster of web resources; calculate a correspondence score between each product in the product catalog and the target audience based on the set of audience attributes; and identify a set of candidate products, in the product catalog, each candidate product exhibiting a correspondence score exceeding a threshold correspondence score. The computer system can then assemble the set of candidate products into a product carousel and insert the product carousel into the ad slot. Accordingly, the computer system can select products for insertion into an ad slot based on audience correspondence with the target biddable object — rather than semantic correspondence between the product and web resource content alone — thereby enabling the advertiser to surface products predicted to resonate with the audience of the target cluster of web resources.

Therefore, the computer system can render digital ads within ad slots on web resources in a target cluster of web resources associated with a particular biddable object, positioned proximal the language signals associated with contextual relevance of each web resource to the particular biddable object, and dynamically tailored to a predicted audience associated with the target biddable object to thereby maximize engagement with ads in ad slots across the cluster of web resources.

### 11.1 Iconography + Graphics

In one implementation, the computer system can access and/or generate a set of template icons for insertion into a transient ad slot associated with a content signal. In particular, in response to associating a first advertiser with a first web resource, the computer system can: access a first set of template icons; select a template icon from the set of template icons based on an association (e.g., semantic association, sentiment association) between the template icon and the content signal; generate a transient ad slot proximal the content signal; and associate the template icon with the transient ad slot.

In one implementation, the computer system can associate a template icon with a particular content signal. In one example, the advertiser profile defines a subset of target content signals for each template icon in the set of template icons. In response to identifying a content signal, in the web resource, in the subset of target content signals associated with a particular template icon, the computer system can select the particular template icon and associate this template icon with the content signal in the web resource.

In another example, the computer system can: characterize a semantic context for each template icon in the set of template icons; calculate a match score for a content signal and a template icon based on a correlation between the semantic context for the template icon and the content signal; and, in response to the match score exceeding a threshold match score, associate the template icons with the content signal.

In another implementation, an advertiser profile can include a set of creative templates (e.g., content database) including a set of template icons and/or a branding (e.g., logo). In response to selecting a particular template icon in the set of template icons, the computer system can annotate the template icon with a branding associated with the advertiser prior to insertion of the template icons into the transient ad slot. For example, the computer system can access a generic template icon (e.g., a ball) associated with an advertiser. The computer system can then: select an overlay, from a set of pre-defined overlays, based on the content signal; overlay the generic template icon with the overlay (e.g., a basketball skin); and annotate the template icon with the branding associated with the advertiser.

Accordingly, in this implementation, when an icon is rendered in a visual element, a user may perceive the template icon representing an overlay related to the content signal and annotated with a particular brand such that the template icon defines a brand ad associated with the advertiser.

In one variation, the computer system can generate a prompt for a request for a particular icon in response to associating an advertiser with a web resource. In particular, the computer system can: identify a semantic context of a content signal in the web resource; generate a prompt representing a request for a template icon based on the semantic context of the content signal; receive the template icon, such as from a generative model; annotate the template icon with a branding associated with the advertiser; and associate the template icon with the content signal in the web resource.

### 11.2 Scroll Events + Content Interaction

Generally, a visual element inserted into a web resource proximal a content signal can: render the template icon in response to a scroll event that moves the visual element into view at a bottom of a window rendered on a display of a computing device; and animate the template icon based on scroll events.

In particular, the computer system can: generate a subset of frames based on the template icon; and serve the subset of frames to the visual element. Then, the visual element can, at a computing device: at a first time, in response to a first scroll-down event that moves the visual element into view of a window rendered on a display of the computing device, render a first region of the template icon corresponding to a first frame in the subset of frames into the visual element; at a second time succeeding the first time, insert a second region of the template icon into the visual element in response to a second scroll-down event that moves the visual element to a second position above the first position of the window, the second region of the template icon corresponding to a second frame succeeding the first frame in the subset of frames; and, at a third time succeeding the second time, insert a last region of the template icon into the visual element in response to a third scroll-down event that moves the visual element to a top of the window, the last region of the template icon corresponding to a last frame succeeding the second frame in the subset of frames.

In one implementation, the subset of frames represents a rotation of the template icon. In this implementation, the visual element can, at a computing device: at a first time, in response to a first scroll-down event that moves the visual element, proximal the content signal, into view of a window rendered on a display of the computing device, render a first portion of the template icon corresponding to a first frame in the subset of frames into the visual element; at a second time succeeding the first time, rotate the template icon to render a second portion of the template icon in response to a second scroll-down event that moves the visual element to a second position above the first position of the window; and, at a third time succeeding the second time, rotate the template icon to render a third portion of the template icon in response to a third scroll-down event that moves the visual element to a top of the window, the third portion of the template icons corresponding to a last frame succeeding the second frame in the subset of frames.

### 11.3 Scroll Events + Animation

In one variation, the computer system can generate an animation for a particular template icon; and insert the animation into the visual element.

In particular, the computer system can: select a content signal for insertion of a template icon; based on the content signal, generate an animation for the template icon; parse the animation into a set of frames; and insert the set of frames, representing the animation, into the visual element. In one example, the computer system can: identify a content signal or phrase (e.g., game-winning basket); select a particular template icon (e.g., a basketball); append the template icon with a branding (e.g., a logo); generate an animation based on the content signal and the template icon (e.g., a “bounce” effect); generate a set of frames representing the animation; and insert the set of frames into the visual element. In this example, the visual element preloads a first frame of the animation before the visual element enters the window displayed on a computing device or loads the first frame of the animation as the visual element enters the window (e.g., from the bottom of the window upward during a scroll-down event).

In response to a scroll-down event that moves the visual element upward from a bottom of a window rendered on a display of the computing device toward a top of the window, the visual element can seek from the first frame through a first subset of frames in the animation in a first direction at a rate corresponding to a scroll rate of the scroll-down event, the first subset of frames spanning a duration of the animation corresponding to a length of the scroll-down event. The visual element can implement methods and techniques as described above to seek forward through frames in the animation as the visual element is moved into the window, such as from the bottom of the window up during a scroll event. In particular, the visual element can seek forward through a subset of frames in the animation corresponding to a distance that the visual element is moved upward within the window during the scroll-down event, and the visual element can cycle from one frame to the next at a rate corresponding to a rate of the scroll-down event.

Accordingly, in this implementation, the visual element can render an animation, proximal a content signal in a web resource, in response to the content signal rendering on a window in a display of a device, proportional to a scroll-down event that moved the content signal into the window, to thereby increase visual engagement by a user based on proximity of the visual element to a content signal in a web resource and movement of an icon rendered within the visual element.

### 11.4 Variation: Phrase Selection + Advertiser Exclusion

In one variation, in response to identifying a set of candidate advertisers (or "eligible buyers") exhibiting relationship scores for a particular web resource exceeding a threshold relationship score, the computer system can select an advertiser, or a subset of candidate advertisers, based on associations between these candidate advertisers.

In one example, the computer system can access a set of whitelisted advertisers associated with a particular advertiser in the set of candidate advertisers. In response to detecting a whitelisted advertiser in the set of candidate advertisers, the computer system can assign a first weight to the particular advertiser. Additionally or alternatively, in response to detecting absence of a whitelisted advertiser in the set of candidate advertisers, the computer system can assign a second weight to a second advertiser, the second weight falling below the first weight. Accordingly, the computer system can weight candidate advertisers higher in response to detecting a subset of candidate advertisers as associated entities.

In another example, the computer system can access a set of blacklisted advertisers (e.g., competitors) associated with a particular advertiser in the set of candidate advertisers. In response to detecting a blacklisted advertiser in the set of candidate advertisers, the computer system can assign a first weight (e.g., 0) to the particular advertiser. Additionally or alternatively, in response to detecting absence of a blacklisted advertiser in the set of candidate advertisers, the computer system can assign a second weight to a second advertiser, the second weight exceeding the first weight. Accordingly, the computer system can exclude advertisers from the set of candidate advertisers in response to detecting competing entities to prevent multiple competitors from advertising in proximal ad slots on a particular webpage.

### 12. Supply Search + Ad Campaigns

In one variation, the computer system can search the ad inventory database for web resources and/or clusters of web resources based on user inputs for a particular ad campaign. In particular, the computer system can receive a request for web resources that correspond to a particular ad campaign, the request defining a theme of an ad campaign representing a concept associated with advertisements in the ad campaign and/or a set of target outcomes for the particular ad campaign. The computer system can then filter the corpus of clusters of web resources for a set of clusters that corresponds with (e.g., “fit” or “match”) the request input by the user. In one implementation, the computer system can rank the set of clusters based on: motif confidence scores associated with these web resources; sentiment scores associated with these web resources; a count of ad slots available within the cluster; and/or an reach score associated with the cluster of web resources.

In one implementation, the computer system can characterize an intent based on implementing natural language processing (“NLP”) for a particular user request. In this implementation, the computer system can identify a sentiment associated with a particular requested motif, and filter the clusters of web resources based on the sentiment. In one example, the computer system can identify a positive sentiment associated with the particular requested motif, and exclude clusters of web resources (and/or web resources within a particular cluster) representing a negative sentiment associated with the particular requested motif. Accordingly, the computer system can identify and render clusters of web resources for a particular requested ad campaign based on correlations between sentiments and motifs between these clusters of web resources and the particular requested ad campaign.

In one variation, the computer system can define ad campaign packages based on multiple selected biddable objects. In particular, the computer system can: receive selection of a first biddable object, in the set of candidate biddable objects, by the user in Block S152; receive selection of a second biddable object, in the set of candidate biddable objects, by the user in Block S152; generate an ad campaign package including the target biddable object and the second biddable object in Block S108; calculate a prospective reach score for the ad campaign package based on a first composite reach score for web resources associated with the target biddable object and a second composite reach score for web resources associated with the second biddable object in Block S109; and serve the ad campaign package, characterized by the prospective reach score, to the user via the user interface in Block S118.

Accordingly, the computer system can: define ad campaigns including a set of biddable objects selected by the advertiser; and automatically distribute ads associated with the ad campaign across clusters of web resources associated with each biddable object in the set of biddable objects. Therefore, the computer system can: enable advertisers to construct multi-object ad campaigns by selecting a combination of biddable objects, each representing a distinct concept and a corresponding cluster of web resources; and automatically distribute ad creatives across web resource clusters corresponding to each selected biddable object — such that a single ad campaign purchase delivers reach across multiple concept-aligned inventory pools without requiring the advertiser to define separate campaigns for each target concept.

### 13. Multiple Advertisers

In one variation, the computer system identifies a set of advertisers associated with a particular cluster of web resources; and proportionally assigns ad slots, within this cluster of web resources, to each advertiser in the set of advertisers.

In particular, the computer system can distribute advertising rights across web resources, in a cluster of web resources associated with a particular biddable object, to a set of advertisers, wherein each advertiser receives advertising rights corresponding to (or proportional to) a bid value placed on the biddable object by the advertiser.

In one example, the computer system can: receive selection of a first biddable object, in the set of biddable objects, by a first advertiser; receive selection of the first biddable object, in the set of biddable objects, by a second advertiser; access a first bid value placed by the first advertiser on the first biddable object in Block S166; access a second bid value placed by the second advertiser on the first biddable object; allocate a first portion of advertising rights to web resources associated with the first biddable object to the first advertiser, the first portion proportional to the first bid value in Block S168; and allocate a second portion of advertising rights to web resources associated with the first biddable object to the second advertiser, the second portion proportional to the second bid value. Accordingly, the computer system can proportionally distribute advertising rights to multiple advertisers based on a corresponding bid value placed on a biddable object by the advertiser.

In one variation, the computer system can implement methods and techniques as described herein for prospective biddable objects. In particular, the computer system can: receive selection of a first prospective biddable object, in the set of prospective biddable objects, by a first advertiser in Block S152; receive selection of the first prospective biddable object, in the set of prospective biddable objects, by a second advertiser; access a first bid value placed by the first advertiser on the first prospective biddable object in Block S166; access a second bid value placed by the second advertiser on the first prospective biddable object; allocate a first portion of advertising rights to web resources associated with the first prospective biddable object to the first advertiser, the first portion proportional to the first bid value in Block S168; and allocate a second portion of advertising rights to web resources associated with the first prospective biddable object to the second advertiser, the second portion proportional to the second bid value.

In one variation, the computer system identifies a first advertiser associated with the first motif, and a second advertiser associated with the first motif. The computer system can then: access a first proportion of ad availability purchased by the first advertiser (e.g., based on a first purchase price); access a second proportion of ad availability purchased by the second advertiser (e.g., based on a first purchase price); assign a first proportion of ad slots associated with the first motif, such as within a first cluster of web resources, to the first advertiser, the first proportion of ad slots proportional to the first proportion of ad availability; and assign a second proportion of ad slots associated with the first motif to the second advertiser, the second proportion of ad slots proportional to the second proportion of ad availability. Accordingly, in this example, the computer system can distribute ad slots associated with a single motif to multiple advertisers based on a proportion of ad slots purchased by each advertiser.

Additionally or alternatively, the computer system can: detect a web resource present in a first cluster of web resources associated with a first biddable object and a second cluster of web resources associated with a second biddable object; and allocate advertising rights to a first advertiser – associated with the first biddable object – and a second advertiser – associated with the second biddable object – according to ad slot placement within the web resource.

In particular, the computer system can: receive selection of a first biddable object, in the set of biddable objects, by a first advertiser in Block S152; receive selection of a second biddable object, in the set of biddable objects, by a second advertiser; and detect presence of a first web resource in a first cluster of web resources associated with the first biddable object and a second cluster of web resources associated with the second biddable object in Block S144. For the first web resource (e.g., at a first instance of the first web resource rendered on a computing device), the computer system can: detect a first contiguous series of words corresponding to the first biddable object; detect a first ad slot proximal the first contiguous series of words; allocate advertising rights for the first ad slot to the first advertiser; detect a second contiguous series of words corresponding to the second biddable object in Block S162; detect a second ad slot proximal the second contiguous series of words; and allocate advertising rights for the second ad slot to the second advertiser.

In another example, the computer system identifies: a first web resource associated with a first motif and a second motif; a first advertiser associated with the first motif; and a second advertiser associated with the second motif. In this example, the computer system can distribute ad slots within the first web resource to the first advertiser and the second advertiser based on ad availability, proximity to language concepts associated with the associated motif, and/or temporal ad placement. In particular, in response to identifying a first purchase time of the first motif preceding a second purchase time of the second motif, the computer system can: render advertisements associated with a first ad campaign, associated with the first advertiser, for a first target time period; and render advertisements associated with a second ad campaign, associated with the second advertiser, for a second target time period succeeding the first target time period. Accordingly, the computer system can render advertisements in ad slots proportional to a purchase time. Additionally or alternatively, in this example, the computer system can: assign a first ad slot, proximal a first set of language concepts associated with the first motif, to the first advertiser, and assign a second ad slot, proximal a second set of language concepts associated with the second motif, to the second advertiser. Accordingly, in this example, the computer system can selectively render advertisements in ad slots, purchased by advertisers, based on semantic proximity.

### 14. Pushing Ad Packages + Offers

In one implementation, the computer system can selectively generate ad campaign packages (or "inventory bundles") for advertisers based on performance of ad slots in these clusters of web resources. In particular, the computer system can implement the methods and techniques described above to identify target biddable objects configured to maximize performance of advertising content according to a particular set of target parameters (e.g., a target outcome, an advertisement format, content type and/or audience metadata). Then, for each biddable object, the computer system can: derive a target impression value based on target outcomes (e.g., target viewership metrics) and/or a count of ad slots available within a corresponding cluster of web resources; and package a subset of ad slots with the target impression value in an inventory offer for review by the advertiser.

In particular, for a first advertiser in a set of advertisers, the computer system can access a set of advertiser characteristics (e.g., product type, advertiser type, target market, target concepts associated with the advertiser) associated with the first advertiser. For each biddable object in the set of biddable objects, the computer system can: derive a set of motifs corresponding to the biddable object; and calculate a correlation between the set of motifs and the set of advertiser characteristics. The computer system can then identify biddable objects corresponding to the set of advertiser characteristics, such as by detecting a first correlation associated with a first biddable object exceeding a threshold correlation. In response to detecting the first correlation associated with the first biddable object exceeding the threshold correlation, the computer system can then: generate a notification recommending bid placement on the first biddable object for ad slots on web resources associated with the first biddable object; and serve the notification to the first advertiser via a user interface.

In one example, the computer system can generate an ad campaign offer for a group of ad slots — paired with a target impression value (e.g., target CPM, target CPC) — affiliated with a cluster of web resources and predicted to yield high engagement according to a target outcome (e.g., viewability, VCR, CTR), and thus increase total value of this group of ad slots for the advertiser. For example, the computer system can: implement methods and techniques described above to derive a set of engagement scores — representing propensity of a user to view advertising content presented within the set of ad slots — for the set of ad slots for a particular cluster of web resources representing a first motif; identify a subset of ad slots, in the set of ad slots, exhibiting an engagement score exceeding a threshold engagement (e.g., exceeding 50 percent viewability); and calculate a total engagement score based on outcome scores of the ad slots in the subset of ad slots. Then, the computer system can: calculate a historical impression value (e.g., an average CPC, an average CPM) for this subset of ad slots based on historical value data collected for ad slots, in the subset of ad slots, affiliated with the cluster of web resources, such as during a preceding day, a preceding week, or a preceding month; access a maximum impression value (e.g., a maximum CPM) for ad slots based on engagement and defined by a set of advertisers, such as within an ad exchange; and derive a target impression value (e.g., a target CPM) for this subset of ad slots based on the historical impression value, the maximum impression value, and the total engagement score. The computer system can then: package this cluster of web resources, the associated subset of ad slots, and the target impression value into an ad campaign offer, characterized by the first motif; and transmit this ad campaign offer to the advertiser within the advertiser platform. Then, in response to receiving confirmation of the inventory offer from the advertiser, the computer system can push advertisements associated with the advertiser to the subset of ad slots across the cluster of web resources.

### 15. Concept Matching

In one variation, the computer system can identify a biddable object and/or a set of biddable objects associated with target metrics present in an advertiser profile. In particular, in this variation, the computer system can: generate a set of advertiser profiles, each advertiser profile including a target motif and a corpus of ad content (e.g., ad campaigns, digital advertisements, interactive digital advertisements) and representing an advertiser in a set of advertisers; calculate a relationship score (or "affinity score") between an advertiser, in the set of advertisers, and a biddable object based on correspondence between the set of target motifs in the advertiser profile and motifs represented by the cluster of web resources; select a set of candidate advertisers — such as based on relationship scores (or "affinity scores") calculated for these advertisers exceeding a threshold relationship score; and “push” the biddable object to the set of candidate advertisers. In response to receiving confirmation (e.g., purchase) from a first advertiser, in the set of candidate advertisers, for the biddable object, the computer system can: associate the first biddable object, represented by the cluster of web resources, with the first advertiser; and, in response to detecting instances of web resources in the cluster of web resources, insert ad content associated with the first advertiser into ad slots on these web resources.

### 15.1 Advertiser Profiles

Generally, the computer system can generate a set of advertiser profiles, for each advertiser in a set of advertisers, — such as based on advertiser characteristics, advertiser content, and/or advertiser whitelists or blacklists. In particular, for a first advertiser, the computer system can generate an advertiser profile including: a set of template icons; a set of target concepts related to target advertising concepts, branding, and/or objects associated with the advertiser; and/or a set of target engagement characteristics.

In one implementation, the computer system can access and/or generate a set of target concepts associated with an advertiser. In one example, the computer system can: access a set of target concepts uploaded to a user portal by a user associated with the advertiser; and aggregate the set of target concepts into the advertiser profile. In another example, the computer system can: access an advertiser webpage representing products and/or services offered by the advertiser; access a set of ads associated with previous advertising campaigns by the advertiser; extract a set of target concepts associated with the advertiser based on the advertiser webpage and the set of ads; and aggregate the set of target concepts into the advertiser profile. Accordingly, the computer system can identify target concepts for an advertiser based on historical and/or current advertising campaigns.

### 15.2 Whitelist + Blacklist Concepts

In one implementation, the computer system can access a whitelist defining a set of inclusion concepts (or "whitelist terms") and/or a blacklist defining a set of exclusion concepts. In particular, the computer system can: receive a whitelist including a set of inclusion concepts (or "whitelist terms"), representing target motifs and/or target concepts; and: upload a blacklist including a set of exclusion concepts, representing exclusion content signals and/or exclusion concepts.

In one example, the computer system can define a set of exclusion concepts (or "blacklist terms") defining content signals and/or themes excluded from ad availability. In particular, a blacklist can define a set of exclusion concepts (or "blacklist terms") and, in response to detecting an exclusion concept in the set of exclusion concepts (or "blacklist terms") in a particular web resource, the computer system can exclude this particular web resource, and accordingly a cluster of web resources, from ad availability.

In one implementation, the computer system can: receive the set of inclusion concepts; identify a target motif in the set of inclusion concepts; and associate the set of target motifs with an advertiser profile and/or a set of advertiser profiles. More specifically, the computer system can extract content signals and/or sentiments (e.g., context) associated with the set of inclusion concepts. For example, the computer system can identify a particular public figure associated with an advertiser based on the set of inclusion concepts. The computer system can then associate a positive sentiment with the particular public figure, such as associating positive sentiment with a motif including a name of the particular public figure.

In another implementation, the computer system can define the set of exclusion concepts — representing a blacklisted set of motifs (e.g., political concepts, controversial topics). In particular, the computer system can receive a first set of exclusion concepts from the user via the user portal. In one example, the computer system can define a second set of exclusion concepts based on the set of inclusion concepts and a set of global exclusion concepts. In particular, the computer system can: identify a particular public figure associated with the advertiser; associate a positive sentiment with a set of content signal(s) associated with the particular public figure; and define an exclusion concept including the set of content signals associated with a negative sentiment, such as in a web resource.

Accordingly, in the foregoing implementations, the computer system can access and/or define inclusion concepts and exclusion concepts for a particular advertiser based on the target concepts identified by an advertiser to enable the advertiser to match with target web resources upon which to insert ad campaigns.

### 16. Advertiser Relationship Scores + Purchase Confirmation

Generally, the computer system can calculate a relationship score for a particular web resource and a particular advertiser (e.g., advertiser) based on a correlation between concepts identified within the web resource and target concepts within an advertiser profile.

In particular, for a first advertiser and a first web resource, the computer system can: access a first advertiser profile associated with the first advertiser; extract a set of target concepts — representing target advertising concepts (e.g., sports, athletes, sentiments, objects, intent signals) from the first advertiser profile; access a set of tags associated with the first web resource and representing concepts present within the first web resource (e.g., recent sports games, news web resources, positive sentiments); calculate a correlation between the set of target concepts and the set of tags; and calculate a relationship score between the first advertiser and the first web resource based on the correlation. In response to the relationship score exceeding a threshold score, the computer system can then associate the first web resource with the first advertiser.

In one implementation, the computer system can calculate a relationship score for a particular web resource and a particular advertiser based on a correlation between a first motif associated with the web resource and target concepts within an advertiser profile. In one example, the computer system can: access a first set of target concepts associated with a first advertiser (e.g., based on an advertiser profile) and a set of pre-defined target motifs; and, in response to identifying a high correlation (e.g., 0.9) between a motif association with the web resource and a target motif in the set of pre-defined target motifs, the computer system can calculate a high relationship score (e.g., 10) for the web resource and the advertiser.

In another implementation the computer system can calculate a relationship score for a particular web resource and a particular advertiser based on: a first correlation between a first motif identified within the web resource and a target concept within an advertiser profile; and a second correlation between a sentiment, associated with the first motif, and a target sentiment based on the advertiser profile.

In one example, the computer system can identify a first motif representing a name of a public figure associated with the advertiser. Then, in response to identifying the name of the public figure in the web resource, the computer system can: flag the first motif for the advertiser in response to detecting positive sentiment associated with the first motif and calculate a high correlation between a sentiment associated with the first motif and a target sentiment based on the advertiser profile. In one implementation, the computer system can then associate the web resource with the advertiser for placement of transient ads proximal content signals representing the first motif in the web resource by: ranking the set of advertisers for the web resource based on relationship scores; selecting a set of candidate advertisers exhibiting relationship scores exceeding a threshold relationship score; and selecting an advertiser, from the set of candidate advertisers, the advertiser exhibiting a highest relationship score.

In response to calculation of the set of advertiser relationship scores, the computer system can “push” these web resources, such as in the form of ad campaign packages, to advertisers in the set of candidate advertisers.

In particular, the computer system can implement methods and techniques described herein to: characterize a cluster of web resources, representing a particular motif, as an ad package offer; calculate a set of relationship scores between a set of advertisers and the first motif; and select a set of candidate advertisers based on the set of relationship scores. The computer system can then: submit the ad package offer to the set of candidate advertisers, such as via an advertiser portal; and, in response to receiving confirmation from a particular advertiser in the set of candidate advertisers representing purchase of the first motif, associate the advertiser with the cluster of web resources such that, when an instance of a web resource, in the cluster of web resources, is initiated, the computer system injects ad content associated with the advertiser into an ad slot (or a host of ad slots) represented across the web resource.

Accordingly, in the foregoing implementation, the computer system can “push” motifs, represented by language concepts, to corresponding advertisers that may purchase these motifs for later identification of ad slots on web resources expressing these motifs and insertion of advertiser content into these ad slots.

### 17. Disclaimer

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor, but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A method comprising:
during a first time period:
accessing a set of biddable objects;
accessing a corpus of web resources; and
for each web resource in the corpus of web resources:
during a second time period succeeding the first time period:
receiving a first user prompt, input by a user, at a user interface;
extracting a first set of language signals from the first user prompt;
identifying a set of candidate biddable objects, in the set of biddable objects, exhibiting correspondence to the first set of language signals;
presenting the set of candidate biddable objects via the user interface; and

2. The method of claim 1, further comprising:
receiving selection of a first biddable object, in the set of biddable objects, by a first user;
receiving selection of a second biddable object, in the set of biddable objects, by a second user;
detecting presence of a first web resource in a first cluster of web resources associated with the first biddable object and a second cluster of web resources associated with the second biddable object; and
for the first web resource:
detecting a first contiguous series of words corresponding to the first biddable object;
detecting a first ad slot proximal the first contiguous series of words;
allocating the first ad slot to ad content supplied by the first user;
detecting a second contiguous series of words corresponding to the second biddable object;
detecting a second ad slot proximal the second contiguous series of words; and
allocating the second ad slot to ad content supplied by the second user.

3. The method of claim 1, further comprising, in response to detecting selection of the target biddable object by the user:
at a first instance of a first web resource, in the target cluster of web resources, rendered by a computing device:
detecting a contiguous series of words representing a first language signal corresponding to the target biddable object;
inserting the first digital ad into a first ad slot proximal the contiguous series of words; and
in response to a first scroll event locating the first ad slot within a viewing window of the computing device, presenting the first digital ad within the first ad slot rendered on the computing device.

4. The method of claim 1, further comprising, in response to detecting selection of the target biddable object by the user:
accessing a first digital ad uploaded by the user; and
at a first instance of a first web resource, in the target cluster of web resources, rendered by a computing device:
detecting a first contiguous series of words representing a first language signal corresponding to the target biddable object;
in response to detecting absence of an ad slot proximal the first contiguous series of words, generating a transient ad slot proximal the first contiguous series of words;
inserting the first digital ad into the transient ad slot; and

5. A method comprising:
accessing a corpus of web resources;
for each web resource in the corpus of web resources:
extracting a set of language signals from content within the web resource;
detecting a motif represented in the web resource based on the set of language signals;
in response to identifying a biddable object, in a set of biddable objects, associated with the motif detected in the web resource, associating the web resource with the biddable object;
accessing a set of historical viewership data for the web resource; and
estimating a projected viewership of the web resource during a future time window based on the set of historical viewership data;
for each biddable object in the set of biddable objects, calculating a reach score based on aggregate projected viewership of web resources associated with the biddable object;
receiving a first user prompt, input by a user, at a user interface;
extracting a first set of language signals from the first user prompt;
identifying a set of candidate biddable objects exhibiting correspondence to the first set of language signals;
presenting the set of candidate biddable objects via the user interface, each candidate biddable object in the set of candidate biddable objects ranked by reach score; and
o allocating ad slots to ad content supplied by the user to instances of web resources associated with the target biddable object and served to viewers.

6. The method of claim 5, further comprising, in response to allocating ad slots to ad content supplied by the user to instances of web resources associated with the target biddable object and served to viewers:
accessing a first digital ad uploaded by the user; and
at a first instance of a first web resource, associated with the target biddable object, rendered by a computing device:
inserting the first digital ad into a first ad slot on the first web resource; and
in response to a first scroll event locating the first ad slot within a viewing window of the computing device, presenting the first digital ad within the first ad slot rendered on the computing device.

7. The method of claim 5, further comprising, in response to detecting selection of the target biddable object by the user:
accessing a first digital ad uploaded by the user; and
at a first instance of a first web resource associated with the target biddable object and rendered by a computing device:
detecting a first contiguous series of words representing a first language signal corresponding to the target biddable object;
inserting the first digital ad into the transient ad slot; and
in response to a first scroll event locating the first contiguous series of words within a viewing window of the computing device, rendering the first digital ad within the transient ad slot.

8. The method of claim 7:
wherein rendering the first digital ad within the transient ad slot comprises:
in response to the first scroll event locating the first contiguous series of words within the viewing window of the computing device, the first contiguous series of words at a first vertical position within the viewing window, rendering a first frame, in a sequence of frames of the first digital ad, within the transient ad slot; and
further comprising:
in response to detecting relocation of the first contiguous series of words from the first vertical position to a second vertical position within the viewing window based on a first scroll-down event, rendering a second frame, in the sequence of frames, of the first digital ad, in replacement of the first frame, within the transient ad slot, the second frame associated with the second vertical position.

9. The method of claim 7:
wherein accessing the first digital ad uploaded by the user comprises:
accessing a sequence of frames compiled into a static image file and representing the first digital ad; and
generating the first digital ad by:

10. The method of claim 7:
wherein accessing the first digital ad uploaded by the user comprises:
accessing a first ad icon;
accessing an ad template:
generating the first digital ad by injecting the first ad icon into frames of the ad template.
